(19) United States
(12) Patent Application Publication
(10) Pub. No.: US 2004/0080242 A1
(43) Pub. Date: Apr. 29, 2004

(54) Liquid injection apparatus

(75) Inventors: Takao Ohnishi, Nishikasugai-Gun (JP); Toshikazu Hirota, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/687,061

(22) Filed: Oct. 16, 2003

(30) Foreign Application Priority Data
Oct. 18, 2002 (JP) 2002-304922
Mar. 19, 2003 (JP) 2003-75809

(51) Int. Cl. H02N 2/00; F02M 51/00

(52) U.S. Cl. 310/314; 123/490

(57) ABSTRACT

A liquid injection apparatus includes an injection unit having piezoelectric/electrostrictive elements; a solenoid-operated on-off discharge valve for discharging fuel under pressure into the injection unit; and an electrical control unit. The electrical control unit sends a solenoid valve on-off signal to the solenoid-operated on-off discharge valve on the basis of operating conditions of an engine, whereby liquid fuel is fed under pressure to the injection unit from the solenoid-operated on-off discharge valve. When liquid pressure in the injection unit detected by a liquid feed path pressure sensor is judged to be in the process of increasing or lowering, the electrical control unit activates the piezoelectric/electrostrictive elements, thereby atomizing injected fuel. When the detected liquid pressure in the injection unit is judged to be a constant, low pressure, the electrical control unit inactivates the piezoelectric/electrostrictive elements, thereby reducing electrical consumption.

### BACKGROUND OF THE INVENTION

1. Field of the Invention

The present invention relates to a liquid injection apparatus for injecting liquid in atomized form into a liquid injection space.

2. Description of the Related Art

Conventionally known liquid fuel injection apparatus is used as a fuel injection apparatus for use in an internal combustion engine. The fuel injection apparatus for use in an internal combustion engine is a so-called electrically controlled fuel injection apparatus, which is in wide use and includes a pressure pump for pressurizing liquid, and a solenoid-operated injection valve. In the electrically controlled fuel injection apparatus, fuel which is pressurized by the pressure pump is injected from an injection port of the solenoid-operated injection valve. Thus, particularly at the time of valve-opening or valve-closing operation for opening or closing the solenoid-operated injection valve, the velocity of injected liquid (injection velocity) is low. As a result, liquid droplets of injected fuel assume a large size and are not of uniform size. Such a size of liquid droplets of fuel and nonuniformity of liquid droplets of fuel increase the amount of unburnt fuel during combustion, leading to increased emission of harmful exhaust gas.

Meanwhile, conventionally, there has been proposed a liquid droplet ejection apparatus configured such that liquid contained in a liquid feed path is pressurized through operation of a piezoelectric electrostriction element so as to eject the liquid from an outlet in the form of fine liquid droplets (see, for example, Japanese Patent Application Laid-Open (kokai) No. S54-90416 (p. 2, FIG. 5)). Such an apparatus utilizes the principle of an ink jet ejection apparatus (see, for example, Japanese Patent Application Laid-Open (kokai) No. H06-40030 (pp. 2-3, FIG. 1)) and can eject finer liquid droplets (liquid droplets of injected fuel) of uniform size as compared with the above-mentioned electrically controlled fuel injection apparatus, thereby exhibiting excellent fuel atomization performance.

The ink jet ejection apparatus can inject fine liquid droplets as expected when used in a relatively steady atmosphere with little variation in temperature, pressure, and the like (e.g., in an office, a classroom, or a like indoor space). However, a liquid ejection apparatus which utilizes the principle of an ink jet ejection apparatus usually fails to exhibit sufficient fuel atomization performance when used under wildly fluctuating atmospheric conditions as found in an internal combustion engine, which involves fluctuating operating conditions. Under the present circumstances, there has not been provided a liquid (fuel) injection apparatus which utilizes the principle of an ink jet ejection apparatus and can inject sufficiently atomized liquid even when used in a mechanical apparatus involving wildly fluctuating atmospheric conditions as in the case of an internal combustion engine.

### SUMMARY OF THE INVENTION

An object of the present invention is to provide a liquid injection apparatus capable of stably injecting liquid in the form of droplets of small size while avoiding waste of electricity even when used under wildly fluctuating conditions within a liquid injection space.

To achieve the above objects, the present invention provides a liquid injection apparatus which comprises an injection device, a pressurizing device, a solenoid-operated on-off discharge valve, a pressure detection device, and an electrical control unit. The injection device includes a liquid discharge nozzle, a first end of the liquid discharge nozzle being exposed to a liquid injection space, a piezoelectric/electrostrictive element which is activated by a piezoelectric-element drive signal that vibrates at a predetermined frequency, a chamber connected to a second end of the liquid discharge nozzle, a liquid feed path connected to the chamber, and a liquid inlet establishing communication between the liquid feed path and the exterior of the injection device. The pressurizing device pressurizes liquid. The solenoid-operated on-off discharge valve includes a solenoid-operated on-off valve which is driven by a solenoid valve on-off signal, and a discharge port which is opened and closed by the solenoid-operated on-off valve. The solenoid-operated on-off discharge valve receives the liquid pressurized by the pressurizing device, and discharges the pressurized liquid into the liquid inlet of the injection device via the discharge port when the solenoid-operated on-off valve is driven to open the discharge port. The pressure detection device detects liquid pressure at a certain location in a liquid path extending from the discharge port of the solenoid-operated on-off discharge valve to the first end of the liquid discharge nozzle exposed to the liquid injection space. The electrical control unit sends the piezoelectric-element drive signal to the piezoelectric/electrostrictive element and the solenoid valve on-off signal to the solenoid-operated on-off discharge valve. The piezoelectric/electrostrictive element is driven in such a manner that the liquid discharged from the solenoid-operated on-off discharge valve is atomized and injected into the liquid injection space in the form of droplets from the liquid discharge nozzle. The electrical control unit is configured in such a manner as to change the piezoelectric-element drive signal on the basis of the liquid pressure detected by the pressure detection device.

According to the above-described configuration, liquid pressurized by the pressurizing device is discharged into the injection device from the solenoid-operated on-off discharge valve. The liquid is atomized through activation of the piezoelectric/electrostrictive element (for example, through volume change of the chamber of the injection device effected by activation of the piezoelectric/electrostrictive element) and is then injected from the liquid discharge nozzle. Since pressure required for injection of liquid into the liquid injection space is generated by the pressurizing device, even when atmospheric conditions (e.g., pressure and temperature) within the liquid injection space fluctuate wildly due to fluctuations in, for example, operating conditions of a machine to which the apparatus is applied, the liquid can be injected and fed stably in the form of expected fine droplets.

In a conventional carburetor, the flow rate of fuel (liquid) is determined according to air velocity within an intake pipe, which is a liquid droplet discharge space, and the degree of atomization varies depending on the air velocity. By contrast, the above-described liquid injection apparatus of the present invention can eject fuel (liquid) by a required amount in a well-atomized condition irrespective of air velocity. Additionally, in contrast to a conventional apparatus in which assist air is fed to a nozzle portion of a fuel injector so as to accelerate fuel atomization, the liquid injection apparatus of the present invention does not require a compressor for feeding assist air, thereby lowering costs.

Furthermore, the pressure detection device detects liquid pressure at a certain location in the liquid path extending from the discharge port of the solenoid-operated on-off discharge valve to one end of the liquid discharge nozzle exposed to the liquid injection space (the pressure of liquid to be injected; i.e., the pressure of liquid contained in the liquid discharge nozzle, the pressure of liquid contained in the chamber, the pressure of liquid contained in the liquid inlet, or the like). Since the electrical control unit is configured in such a manner as to change the piezoelectric-element drive signal on the basis of the liquid pressure detected by the pressure detection device, when the piezoelectric/electrostrictive element has no need to be activated; for example, when the pressure of liquid to be injected is sufficiently high to impart a relatively small size to droplets of the liquid without atomization of the liquid by the piezoelectric/electrostrictive element or when the pressure of liquid to be injected is sufficiently low so that the liquid is not injected from the liquid discharge nozzle, the activation of the piezoelectric/electrostrictive element can be reliably stopped. As a result, waste of electricity can be avoided.

In this case, the pressure detection device may be a piezoelectric element or a piezoresistance element disposed in the liquid feed path, the liquid inlet, or the chamber. Also, the pressure detection device may be the piezoelectric/electrostrictive element of the injection device.

Particularly, when the piezoelectric/electrostrictive element of the injection device is also used as the pressure detection device, the need to provide a pressure detection device is eliminated, thereby lowering the cost of the liquid injection apparatus.

Preferably, the electrical control unit of the liquid injection apparatus is configured in such a manner as to generate the piezoelectric-element drive signal so as to activate the piezoelectric/electrostrictive element when the liquid pressure detected by the pressure detection device is in the process of increasing or decreasing because of generation of the solenoid valve on-off signal or stoppage of generation of the solenoid valve on-off signal, and in such a manner as not to generate the piezoelectric-element drive signal when the liquid pressure detected by the pressure detection device is a constant, low pressure because of disappearance of the solenoid valve on-off signal.

According to the above-described configuration, the electrical control unit reliably detects at least the case where the pressure of liquid to be injected is in the process of increasing because of generation of the solenoid valve on-off signal or in the process of decreasing because of stoppage of generation of the solenoid valve on-off signal. Upon detection of such a case, the electrical control unit generates the piezoelectric-element drive signal to thereby activate the piezoelectric/electrostrictive element. Therefore, in the case where the injection velocity of liquid is not sufficiently high to sufficiently atomize the liquid, due to relatively low injection pressure of the liquid at the time when the pressure of the liquid is in the process of increasing or decreasing, the piezoelectric/electrostrictive element can be reliably activated, whereby the liquid can be appropriately atomized.

Further preferably, the electrical control unit is configured in such a manner as not to generate the piezoelectric-element drive signal when the liquid pressure detected by the pressure detection device is equal to or higher than a high-pressure threshold.

When the pressure of liquid to be injected increases to a sufficiently high pressure (a pressure equal to or higher than the high-pressure threshold, or a pressure equal to or higher than a first predetermined value) because of generation of the solenoid valve on-off signal, the velocity of liquid injected into the liquid injection space from the liquid discharge nozzle of the injection device (the injection velocity, or the travel velocity of a liquid column) becomes sufficiently high, whereby the liquid assumes the form of droplets of a relatively small size by virtue of surface tension. Therefore, through employment of the above configuration—in which the piezoelectric-element drive signal is not generated when the liquid pressure detected by the pressure detection device is equal to or higher than the high-pressure threshold—unnecessary generation of the piezoelectric-element drive signal can be avoided, whereby the electrical consumption of the liquid injection apparatus can be reduced.

Also, preferably, the electrical control unit is configured in such a manner as to continuously generate the piezoelectric-element drive signal, during a period in which the liquid pressure detected by the pressure detection device is higher than a low-pressure threshold because of generation of the solenoid valve on-off signal, and is configured in such a manner as to generate the solenoid valve on-off signal such that the pressure of liquid contained in the liquid feed path increases steeply immediately after start of generation of the solenoid valve on-off signal and subsequently decreases gradually at a pressure change rate whose absolute value is smaller than that of a pressure change rate at the time of the increase of the liquid pressure.

In this case, preferably, the electrical control unit is configured in such a manner as to change the solenoid valve on-off signal on the basis of the liquid pressure detected by the pressure detection device.

According to the above-described configuration, the pressure of liquid contained in the liquid feed path increases steeply immediately after start of generation of the solenoid valve on-off signal, thereby immediately starting injection of liquid droplets. Subsequently, the pressure of liquid contained in the liquid feed path continues to decrease in a relatively gradual manner. Therefore, the velocity of a preceding injected liquid droplet is higher than that of a subsequent injected liquid droplet, thereby reducing the possibility that liquid droplets collide each other to form a liquid droplet of a greater size.

By virtue of being configured in such a manner as to change the solenoid valve on-off signal on the basis of the liquid pressure detected by the pressure detection device, the electrical control unit, for example, can accurately detect a point of time when the pressure of liquid contained in the liquid feed path reaches near maximum pressure, and can change the solenoid valve on-off signal to decrease, from that point of time, the pressure of liquid contained in the liquid feed path in a relatively gradual manner. Therefore, the liquid contained in the liquid feed path can avoid remaining at near maximum pressure for a long period of time, thereby ensuring avoidance of collision of liquid droplets.

Also, preferably, the electrical control unit is configured in such a manner as to change the frequency of the piezoelectric-element drive signal according to the liquid pressure detected by the pressure detection device.

Since the pressure of liquid to be injected determines the velocity of liquid injected from the liquid discharge nozzle (injection velocity), the degree of atomization of liquid varies with the pressure of the liquid. Therefore, through employment of the above-described configuration—in which the frequency of the piezoelectric-element drive signal is changed according to the liquid pressure detected by the pressure detection device—liquid droplets of a desired size can be obtained.

Also, preferably, the electrical control unit is configured in such a manner as to change the piezoelectric-element drive signal such that the frequency of the piezoelectric-element drive signal increases with an increase in the liquid pressure detected by the pressure detection device.

As the pressure of liquid to be injected increases, the flow rate of liquid injected from the liquid discharge nozzle increases. Therefore, through application of the piezoelectric-element drive signal whose frequency increases with the liquid pressure detected by the pressure detection device, the size of liquid droplets obtained through atomization can be rendered uniform, irrespective of the liquid pressure.

Further preferably, the electrical control unit is configured in such a manner as to change the piezoelectric-element drive signal such that the volume change quantity of the chamber reduces with an increase in the liquid pressure detected by the pressure detection device.

As the pressure of liquid to be injected increases, the velocity of liquid injected from the liquid discharge nozzle increases. Thus, without an increase of the volume change quantity (the maximum value of volume change quantity; i.e., the maximum volume change quantity) of the chamber, injected liquid droplets assume a relatively small size by virtue of surface tension. Therefore, when the pressure of liquid to be injected is high, a reduction in volume change quantity of the chamber does not lead to an excessive increase in liquid droplet size. Thus, through employment of the above-described configuration, in which the piezoelectric-element drive signal is changed such that the volume change quantity of the chamber reduces with an increase in the liquid pressure detected by the pressure detection device while the liquid pressure is high, it is possible to prevent the chamber volume from changing to an unnecessarily great extent (i.e., possible to prevent the piezoelectric/electrostrictive element from deforming by an unnecessarily large amount), to thereby reduce the electrical consumption of the liquid injection apparatus.

Notably, the electrical control unit may be configured in such a manner as to start generation of the piezoelectric-element drive signal immediately before a point of time when the pressure of liquid contained in the liquid feed path starts to increase, due to generation of the solenoid valve on-off signal, from a constant, low pressure (a pressure that the liquid contained in the liquid feed path reaches as a result of continuation of a state in which liquid pressurized by the pressurizing device is not fed to the liquid feed path).

According to the above-described configuration, at a point of time when the pressure of liquid contained in the liquid feed path starts to rise due to generation of the solenoid valve on-off signal; i.e., at a point of time when injection of liquid droplets from the liquid discharge nozzle of the injection device possibly starts, the piezoelectric/electrostrictive element has already been driven by the piezoelectric-element drive signal, and thus vibration energy has already been applied to the liquid. Therefore, from the beginning of injection of the liquid, liquid droplets can be injected in a reliably atomized condition.

Also, the above-described electrical control unit can be said to be configured in such a manner as to continuously generate the piezoelectric-element drive signal up to a point of time immediately after the pressure of liquid contained in the liquid feed path lowers to the aforementioned constant, low pressure as a result of stoppage of generation of the solenoid valve on-off signal.

Since, for a while after a point of time when generation of the solenoid valve on-off signal is stopped, the pressure of liquid contained in the liquid feed path is higher than the aforementioned constant, low pressure, the injection of the liquid from the liquid discharge nozzle of the injection device continues. Therefore, through employment of the above-described configuration, in which generation of the piezoelectric-element drive signal is continued up to a point of time immediately after the pressure of liquid contained in the liquid feed path lowers to the aforementioned constant, low pressure as a result of stoppage of generation of the solenoid valve on-off signal, the piezoelectric/electrostrictive element can be driven by the piezoelectric-element drive signal so as to apply vibration energy to the liquid during a period in which the injection of liquid droplets from the liquid discharge nozzle of the injection device continues after stoppage of generation of the solenoid valve on-off signal. As a result, even after disappearance of the solenoid valve on-off signal (until termination of injection of liquid), the liquid can be injected in a reliably atomized condition.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a schematic diagram showing a liquid injection apparatus according to a first embodiment of the present invention and applied to an internal combustion engine;

FIG. 2 is a view showing a solenoid-operated on-off discharge valve and an injection unit shown in FIG. 1;

FIG. 3 is an enlarged sectional view showing portions of the solenoid-operated on-off discharge valve and the injection unit shown in FIG. 2, the portions being located near the distal end portion of the solenoid-operated on-off discharge valve;

FIG. 4 is a plan view of the injection device shown in FIG. 2;

FIG. 5 is a sectional view of the injection device cut by a plane extending along line V-V of FIG. 4;

FIG. 6 is a detailed block diagram of an electrical control unit shown in FIG. 1;

FIG. 7 is a timing chart showing signals generated in the electrical control unit shown in FIG. 6;

FIG. 8 is a detailed circuit diagram of the electrical control unit shown in FIG. 6;

FIG. 9 is a flowchart showing a routine which an electronic engine control unit shown in FIG. 6 executes;

FIG. 10 is a flowchart showing a routine which an electronic engine control unit shown in FIG. 6 executes;

FIG. 11 is a timing chart showing (A) a drive voltage signal, (B) a solenoid valve on-off signal, (C) liquid pressure in a liquid feed path, (D) a piezoelectric-element activation instruction signal, and (E) a piezoelectric-element drive signal to be applied to piezoelectric/electrostrictive elements;

FIG. 12 is a view showing the condition of liquid injected from the liquid injection apparatus shown in FIG. 1;

FIG. 13 is a timing chart showing the action of a liquid injection apparatus according to a second embodiment of the present invention by use of signals similar to those of FIG. 11;

FIG. 14 is a flowchart showing a routine which a fuel injection control microcomputer of the liquid injection apparatus according to the second embodiment executes;

FIG. 15 is a flowchart showing a routine which the fuel injection control microcomputer of the liquid injection apparatus according to the second embodiment executes;

FIG. 16 is a timing chart showing the action of a liquid injection apparatus according to a third embodiment of the present invention by use of signals similar to those of FIG. 11;

FIG. 17 is a flowchart showing a routine which the fuel injection control microcomputer of the liquid injection apparatus according to the third embodiment executes;

FIG. 18 is a timing chart showing the action of a liquid injection apparatus according to a fourth embodiment of the present invention by use of signals similar to those of FIG. 11;

FIG. 19 is a timing chart showing a piezoelectric-element drive signal, among others, in a period of time when liquid pressure in a liquid feed path is in the process of increasing in the liquid injection apparatus according to the fourth embodiment;

FIG. 20 is a flowchart showing a routine which a fuel injection control microcomputer of the liquid injection apparatus according to the fourth embodiment executes;

FIG. 21 is a timing chart showing the action of a liquid injection apparatus according to a modification of the fourth embodiment by use of signals similar to those of FIG. 11;

FIG. 22 is a timing chart showing the action of a liquid injection apparatus according to a modification of the embodiments of the present invention;

FIG. 23 is a plan view of a liquid injection device according to another modification of the embodiments of the present invention; and

FIG. 24 is a sectional view of the liquid injection device of FIG. 23 cut by a plane extending along line XXIV-XXIV of FIG. 23.

### DESCRIPTION OF THE PREFERRED EMBODIMENTS

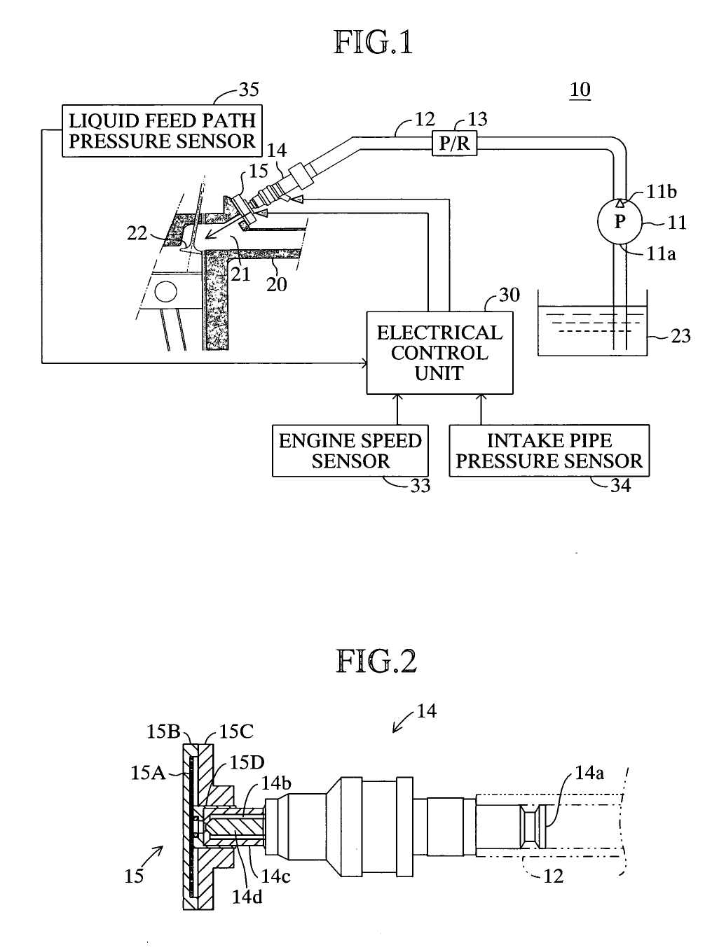

Embodiments of a liquid injection apparatus (liquid atomization apparatus, liquid feed apparatus, or liquid droplet discharge apparatus) according to the present invention will be described with reference to the drawings. FIG. 1 schematically shows a first embodiment of a liquid injection apparatus 10 according to the present invention. The liquid injection apparatus 10 is applied to an internal combustion engine, which is a mechanical apparatus requiring atomized liquid.

The liquid injection apparatus 10 is adapted to inject atomized liquid (liquid fuel; e.g., gasoline; hereinafter may be called merely as “fuel”) into a fuel injection space 21 defined by an intake pipe (intake port) 20 of an internal combustion engine such that the injected atomized liquid is directed to the back surface of an intake valve 22. The liquid injection apparatus 10 includes a pressure pump (fuel pump) 11, which serves as a pressurizing device; a liquid feed pipe (fuel pipe) 12, in which the pressure pump 11 is installed; a pressure regulator 13, which is installed in the liquid feed pipe 12 on the discharge side of the pressure pump 11; a solenoid-operated on-off discharge valve 14; an injection unit (atomization unit) 15, which includes a plurality of chambers having respective piezoelectric/electrostrictive elements formed at least on their walls and a plurality of liquid discharge nozzles in order to atomize fuel to be injected into the fuel injection space 21; and an electrical control unit 30 for sending a solenoid valve on-off signal serving as a drive signal, and a piezoelectric-element drive signal for changing the chamber volume (for activating the piezoelectric/electrostrictive elements), to the solenoid-operated on-off discharge valve 14 and the injection unit 15, respectively.

The pressure pump 11 communicates with a bottom portion of the liquid storage tank (fuel tank) 23 and includes an introduction portion 11a, to which fuel is fed from the liquid storage tank 23, and a discharge portion 11b connected to the liquid feed pipe 12. The pressure pump 11 takes in fuel from the liquid storage tank 23 through the introduction portion 11a; pressurizes the fuel to a pressure (this pressure is called “pressure pump discharge pressure”) which enables injection of the fuel into the fuel injection space 21 via the pressure regulator 13, the solenoid-operated on-off discharge valve 14, and the injection unit 15 (even when the piezoelectric/electrostrictive elements of the injection unit 15 are inactive); and discharges the pressurized fuel into the liquid feed pipe 12 from the discharge portion 11b.

Pressure in the intake pipe 20 is applied to the pressure regulator 13 through unillustrated piping. On the basis of the pressure, the pressure regulator 13 lowers (or regulates) the pressure of fuel pressurized by the pressure pump 11 such that the pressure of fuel in the liquid feed pipe 12 between the pressure regulator 13 and the solenoid-operated on-off discharge valve 14 becomes a pressure (called “regulation pressure”) that is higher by a predetermined pressure (a constant pressure) than the pressure in the intake pipe 20. As a result, when the solenoid-operated on-off discharge valve 14 is opened for a predetermined time, fuel is injected into the intake pipe 20 in an amount substantially proportional to the predetermined time, irrespective of pressure in the intake pipe 20.

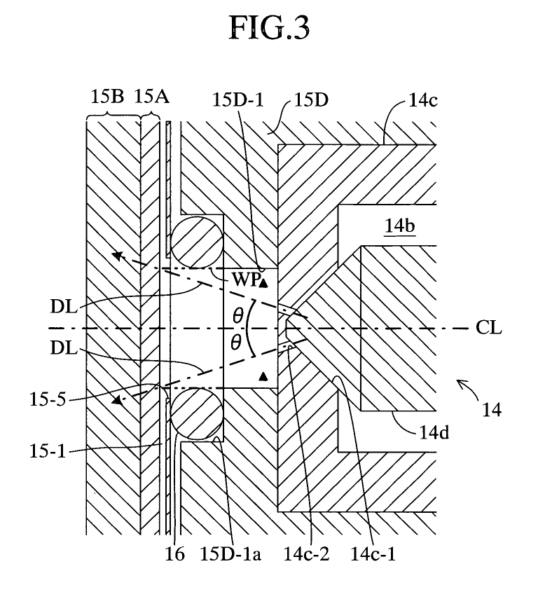

The solenoid-operated on-off discharge valve 14 is a known fuel injector (solenoid-operated on-off injection valve) which has been widely employed in an electrically controlled fuel injection apparatus of an internal combustion engine. FIG. 2 is a front view of the solenoid-operated on-off discharge valve 14, showing a section of a distal end portion of the valve 14 cut by a plane including the centerline of the valve 14 and a section of the injection unit 15—which is fixedly attached to the valve 14—cut by the same plane. FIG. 3 is an enlarged sectional view showing portions of the solenoid-operated on-off discharge valve 14 and the injection unit 15 shown in FIG. 2, the portions being located near the distal end portion of the solenoid-operated on-off discharge valve 14.

As shown in FIG. 2, the solenoid-operated on-off discharge valve 14 includes a liquid introduction port 14a, to which the liquid feed pipe 12 is connected; an external tube portion 14c, which defines a fuel path 14b communicating with the liquid introduction port 14a; a needle valve 14d, which serves as a solenoid-operated on-off valve; and an unillustrated solenoid mechanism for driving the needle valve 14d. As shown in FIG. 3, a conical valve seat portion 14c-1—which assumes a shape substantially similar to that of a distal end portion of the needle valve 14d—is provided at a center portion of the distal end of the external tube portion 14c; and a plurality of discharge ports (through-holes) 14c-2—which establish communication between the interior (i.e., the fuel path 14b) of the external tube portion 14c and the exterior of the external tube portion 14c—are provided in the vicinity of an apex (a distal end portion) of the valve seat portion 14c-1. The discharge ports 14c-2 are inclined by an angle θ with respect to an axis CL of the needle valve 14d (solenoid-operated on-off discharge valve 14). Notably, the view is not shown, but when the external tube portion 14c is viewed from the direction of the axis CL, the plurality of discharge ports 14c-2 are arranged equally spaced on the same circumference.

Through employment of the above configuration, the solenoid-operated on-off discharge valve 14 functions in the following manner: the needle valve 14d is driven by the solenoid mechanism so as to open the discharge ports 14c-2, whereby the fuel contained in the fuel path 14b is discharged (injected) via the discharge ports 14c-2. This state is represented as “the solenoid-operated on-off discharge valve 14 is opened.” The state in which the needle valve 14d closes the discharge ports 14c-2 is represented as “the solenoid-operated on-off discharge valve 14 is closed.” Since the discharge ports 14-2c are inclined with respect to the axis CL of the needle valve 14d, fuel discharged as mentioned above is injected in such a manner as to spread out (in a cone shape) along the side surface of a cone whose centerline coincides with the axis CL.

As shown in FIG. 2, the injection unit 15 includes an injection device 15A, an injection device fixation plate 15B, a retaining unit 15C for retaining the injection device fixation plate 15B, and a sleeve 15D for fixing the distal end of the solenoid-operated on-off discharge valve 14.

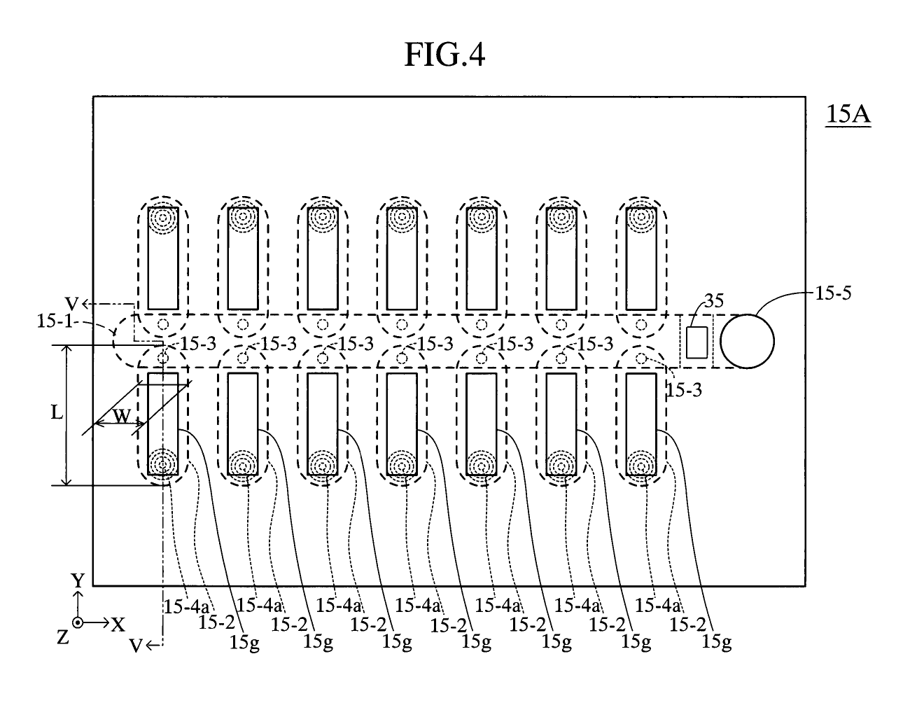

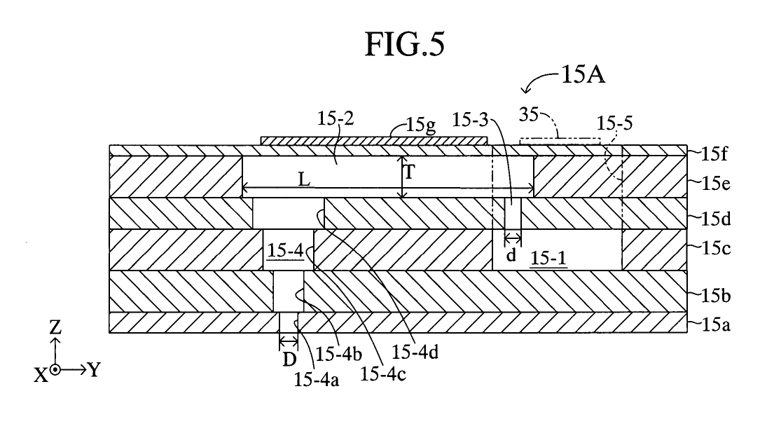

As shown in FIG. 4, a plan view showing the injection device 15A, and FIG. 5, a sectional view of the injection device 15A cut by a plane extending along line V-V of FIG. 4, the injection device 15A assumes the shape of a substantially rectangular parallelepiped whose sides extend in parallel with mutually orthogonal X-, Y-, and Z-axes, and includes a plurality of ceramic thin-plate members (hereinafter called “ceramic sheets”) 15a to 15f, which are sequentially arranged in layers and joined under pressure; and a plurality of piezoelectric/electrostrictive elements 15g fixedly attached to the outer surface (a plane extending along the X-Y plane and located toward the positive side along the Z-axis) of the ceramic sheet 15f. The injection device 15A includes internally a liquid feed path 15-1; a plurality of (herein seven per row, 14 in total) mutually independent chambers 15-2; a plurality of liquid introduction holes 15-3 for establishing communication between the chambers 15-2 and the liquid feed path 15-1; a plurality of liquid discharge nozzles 15-4, one end of each of the liquid discharge nozzles 15-4 being substantially exposed to the liquid injection space 21 so as to establish communication between the chambers 15-2 and the exterior of the injection device 15A; and a liquid inlet 15-5.

The liquid feed path 15-1 is a space defined by the side wall surface of an oblong cutout which is formed in the ceramic sheet 15c and whose major and minor axes extend along the X- and Y-axis, respectively; the upper surface of the ceramic sheet 15b; and the lower surface of the ceramic sheet 15d.

Each of the chambers 15-2 is an elongated space (a longitudinally extending liquid flow path portion) defined by the side wall surface of an oblong cutout formed in the ceramic sheet 15e and having major and minor axes extending along the direction of the Y-axis and the direction of the X-axis, respectively, the upper surface of the ceramic sheet 15d, and the lower surface of the ceramic sheet 15f. One end portion with respect to the direction of the Y axis of each of the chambers 15-2 extends to a position located above the liquid feed path 15-1, whereby each of the chambers 15-2 communicates, at the position corresponding to the one end portion, with the liquid feed path 15-1 via the cylindrical liquid introduction hole 15-3 having diameter d and formed in the ceramic sheet 15d. Hereinafter, the diameter d may be called merely as “introduction hole diameter d.” The other end portion with respect to the direction of the Y axis of each of the chambers 15-2 is connected to the other end of the corresponding liquid discharge nozzle 15-4. The above configuration allows liquid to flow in the chambers 15-2 (flow path portions) from the liquid introduction holes 15-3 to the side toward the liquid discharge nozzles 15-4.

Each of the liquid discharge nozzles 15-4 includes a cylindrical through-hole which is formed in the ceramic sheet 15a and has diameter D and whose one end (a liquid injection port or an opening exposed to the liquid injection space) 15-4a is substantially exposed to the liquid injection space 21; and cylindrical communication holes 15-4b to 15-4d, which are formed in the ceramic sheets 15b to 15d, respectively, such that their size (diameter) increases stepwise toward the corresponding chamber 15-2 from the liquid injection port 15-4a. The axes of the liquid discharge nozzles 15-4 are in parallel with the Z-axis. Hereinafter, the diameter D may be called merely as “nozzle diameter D.”

The liquid inlet 15-5 is a space defined by the side wall of a cylindrical through-hole which is formed in the ceramic sheets 15d to 15f at an end portion of the injection device 15A in the positive direction of the X-axis and at a substantially central portion of the injection device 15A in the direction of the Y-axis. The liquid inlet 15-5 is adapted to establish communication between the liquid feed path 15-1 and the exterior of the injection device 15A. The liquid inlet 15-5 is connected to an upper portion of the liquid feed path 15-1 on an imaginary plane located in the boundary plane between the ceramic sheets 15d and 15c. A portion which partially constitutes the liquid feed path 15-1 and faces the imaginary plane; i.e., a portion of the upper surface of the ceramic sheet 15b is a plane portion in parallel with the imaginary plane.

The shape and size of the chambers 15-2 will be additionally described. Each of the chambers 15-2 assumes a substantially rectangular cross section as cut at its longitudinally (along the direction of the Y-axis) central portion (flow path portion) by a plane (X-Z plane) perpendicular to the direction of liquid flow. Major axis L (length along the Y-axis) and minor axis W (length along the X-axis, or length of a first side of the rectangle) of the elongated flow path portion are 3.5 mm and 0.35 mm, respectively. Height T (length along the Z-axis, or length of a second side perpendicular to the first side of the rectangle) of the flow path portion is 0.15 mm. In other words, in the rectangular cross-sectional shape of the flow path portion, the ratio (T/W) of the length (height T) of the second side perpendicular to the first side (minor axis W) on which the piezoelectric/electrostrictive element is provided, to the length of the first side (minor axis W) is 0.15/0.35=0.43. Preferably, the ratio (T/W) is greater than zero (0) and smaller than one (1). Through selection of such a ratio (T/W), vibration energy of the piezoelectric/electrostrictive elements 15g can be efficiently transmitted to fuel contained in the corresponding chambers 15-2.

The diameter D of the liquid discharge nozzle end portion 15-4a and the diameter d of the liquid introduction hole 15-3 are 0.031 mm and 0.025 mm, respectively. In this case, preferably, cross-sectional area S1 (=W×T) of the flow path of the chamber 15-2 is greater than cross-sectional area S2 (=π·(D/2)²) of the liquid discharge nozzle end portion 15-4a and greater than cross-sectional area S3 (=π·(d/2)²) of the liquid introduction hole 15-3. Also, preferably, for atomization of liquid, the cross-sectional area S2 is greater than the cross-sectional area S3.

The piezoelectric/electrostrictive elements 15g are slightly smaller than the corresponding chambers 15-2 as viewed in plane (as viewed from the positive direction of the Z-axis); are fixed to the upper surface (a wall surface including a side of the rectangular cross-sectional shape of the flow path portion of each chamber 15-2) of the ceramic sheet 15f in such a manner as to be disposed within the corresponding chambers 15-2 as viewed in plane; and are activated (driven) in response to a piezoelectric-element drive signal DV (also called a “piezoelectric/electrostrictive-element drive signal DV”) which a piezoelectric-element drive signal generation device (circuit) of the electrical control unit 30 applies between unillustrated electrodes provided on the upper and lower surfaces of each of the piezoelectric/electrostrictive elements 15g, thereby causing deformation of the ceramic sheet 15f (upper walls of the chambers 15-2), and an associated volume change ΔV of the corresponding chambers 15-2.

The following method is employed for making the ceramic sheets 15a to 15f and a laminate of the ceramic sheets 15a to 15f.

1: Ceramic green sheets are formed by use of zirconia powder having a particle size of 0.1 to several micrometers.

2: Punching is performed on this ceramic green sheet by use of punches and dies so as to form cutouts corresponding to those in the ceramic sheets 15a to 15e shown in FIG. 5 (cutouts corresponding to the chambers 15-2, the liquid introduction holes 15-3, the liquid feed path 15-1, the liquid discharge nozzles 15-4, and the liquid inlet 15-5 (see FIG. 4)).

3: The ceramic green sheets are arranged in layers. The resultant laminate is heated under pressure, followed by subjection to firing for 2 hours at 1,550° C. for integration.

The piezoelectric/electrostrictive elements 15g each being sandwiched between electrodes are formed on the completed laminate of ceramic sheets at positions corresponding to the chambers. Thus is fabricated the injection device 15A. Through such fabrication of the injection device 15A in a monolithic form by use of zirconia ceramic, characteristics of zirconia ceramic allow the injection device 15A to maintain high durability against frequent deformation of the wall surface 15f effected by the piezoelectric/electrostrictive elements 15g; and a liquid injection device having a plurality of liquid discharge nozzles 15-4 can be implemented in such a small size of up to several centimeters in overall length and can be readily fabricated at low cost.

As shown in FIGS. 2 and 3, the thus-configured injection device 15A is fixedly attached to the injection device fixation plate 15B. The injection device fixation plate 15B assumes a rectangular shape slightly greater than the injection device 15A as viewed in plane. The injection device fixation plate 15B has unillustrated through-holes formed therein such that, when the injection device 15A is fixedly attached thereto, the through-holes face the corresponding liquid injection ports 15-4a of the injection device 15A, thereby exposing the liquid injection ports 15-4a to the exterior of the injection device 15A via the through-holes. The injection device fixation plate 15B is fixedly retained at its peripheral portion by means of the retaining unit 15C.

The retaining unit 15C assumes an external shape identical with that of the injection device fixation plate 15B as viewed in plane. As shown in FIG. 1, the retaining unit 15C is fixedly attached to the intake pipe 20 of the internal combustion engine at its peripheral portion by use of unillustrated bolts. As shown in FIG. 2, a through-hole whose diameter is slightly greater than that of the external tube portion 14c of the solenoid-operated on-off discharge valve 14 is formed in the retaining unit 15C at a central portion thereof. The external tube portion 14c is inserted into the through-hole.

As shown in FIGS. 2 and 3, the sleeve (a closed space formation member) 15D assumes such a cylindrical shape that its inside diameter is equal to the outside diameter of the external tube portion 14c of the solenoid-operated on-off discharge valve 14 and that its outside diameter is equal to the inside diameter of the aforementioned through-hole of the retaining unit 15C. One end of the sleeve 15D is closed, and the other end is opened. As shown in FIG. 3, an opening 15D-1 having a diameter substantially equal to that of the liquid inlet 15-5 of the injection device 15A is formed in the closed end portion of the sleeve 15D at the center thereof. An O-ring groove 15D-1a is formed on an inner circumferential wall surface forming the opening 15D-1 and on the outer surface of the closed end portion of the sleeve 15D.

The external tube portion 14c of the solenoid-operated on-off discharge valve 14 is press-fitted into the sleeve 15D from the open end of the sleeve 15D until the external tube portion 14c abuts the inside wall surface of the closed end of the sleeve 15D. The sleeve 15D is press-fitted into the aforementioned through-hole of the retaining unit 15C. At this time, an O-ring 16 fitted into the O-ring groove 15D-1a abuts the ceramic sheet 15f of the injection device 15A.

In this manner, the solenoid-operated on-off discharge valve 14 and the injection unit 15 are assembled together, whereby a closed cylindrical space is formed between the discharge ports 14c-2 of the solenoid-operated on-off discharge valve 14 (a portion that can also be said to be the closed end face (the outside face of the closed end)—where the discharge ports 14c-2 are formed—of the external tube portion 14c of the solenoid-operated on-off discharge valve 14, or a portion that can also be said to be the outside surface of a wall portion of the cylindrical external tube portion 14c where the discharge ports 14c-2 is formed) and the liquid inlet 15-5 of the injection device 15A. In this state, the axis of the opening (closed cylindrical space) 15D-1 of the sleeve 15D coincides with the axis of the liquid inlet 15-5 of the injection device 15A and with the axis CL of the needle valve 14d. As described above, the sleeve 15D is disposed between the discharge ports 14c-2 of the solenoid-operated on-off discharge valve 14 and the liquid inlet (liquid inlet portion) 15-5 of the injection device 15A, and forms a closed cylindrical space—whose diameter is substantially equal to that of the liquid inlet 15-5 and whose axis coincides with the axis CL of the liquid inlet 15-5 and with the axis CL of the needle valve 14d—between the discharge ports 14c-2 and the liquid inlet 15-5.

As mentioned previously, the discharge ports 14c-2 are inclined by angle θ with respect to the axis CL of the needle valve 14d (the axis of the closed cylindrical space). Accordingly, fuel discharged from the solenoid-operated on-off discharge valve 14 spreads out toward the injection device 15A at the angle θ with respect to the axis CL, in the opening 15D-1 (i.e., the aforementioned closed cylindrical space) of the sleeve 15D. In other words, the distance of fuel discharged from the discharge ports 14c-2 as measured from the axis CL of the closed cylindrical space increases with the distance from the discharge ports 14c-2 toward the liquid inlet 15-5.

In the present embodiment, the angle θ is determined such that the thus-discharged fuel reaches the aforementioned plane portion of the liquid feed path 15-1 (the upper surface of the ceramic sheet 15b) without reaching the inner circumferential wall surface (excluding the inner circumferential wall surface of the O-ring groove 15D-1a) which forms the opening 15D-1 (i.e., the aforementioned closed cylindrical space) of the sleeve 15D, and without reaching a wall surface WP (represented in FIG. 3 by the double-dot-and-dash line) which is formed through imaginary extension of the inner circumferential wall surface to the plane portion of the liquid feed path 15-1.

In other words, the solenoid-operated on-off discharge valve 14 is arranged and configured such that the discharge flow line (represented in FIG. 3 by the dot-and-dash line DL) of liquid discharged from the discharge ports 14c-2 directly intersects the plane portion of the liquid feed path 15-1 without intersecting the cylindrical side wall 15D-1 which forms the closed space of the sleeve 15D, and without intersecting the side wall WP which is formed through imaginary extension of the side wall 15D-1 to the plane portion of the liquid feed path 15-1.

Through employment of the above configuration, fuel which is discharged from the discharge ports 14c-2 of the solenoid-operated on-off discharge valve 14 and fed into the liquid feed path 15-1 via the liquid inlet 15-5 is introduced into the chambers 15-2 via the corresponding liquid introduction holes 15-3. Vibration energy is applied to the fuel contained in the chambers 15-2, whereby the fuel is injected in the form of fine (atomized) liquid droplets into the intake pipe 20 via the liquid injection ports 15-4a of the liquid discharge nozzles 15-4 and the through-holes formed in the injection device fixation plate 15B.

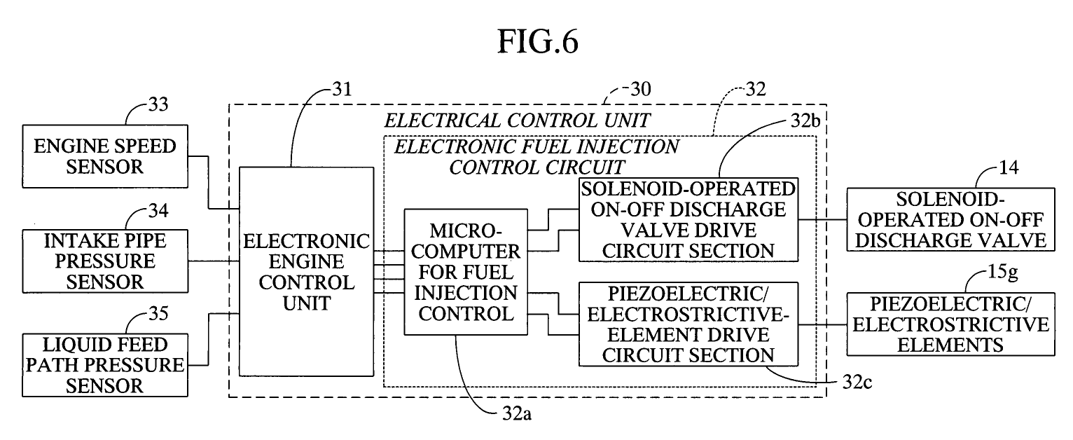

As shown in FIG. 6, the electrical control unit 30 includes an electronic engine control unit 31 and an electronic fuel injection control circuit 32, which is connected to the electronic engine control unit 31.

The electronic engine control unit 31 is connected to sensors, such as a known engine speed sensor 33, a known intake pipe pressure sensor 34, and a liquid feed path pressure sensor 35. Receiving engine speed N and intake pipe pressure P from these sensors, the electronic engine control unit 31 determines the amount of fuel and injection start timing required for an internal combustion engine, and sends signals related to the determined amount of fuel and injection start timing, such as a drive voltage signal, to the electronic fuel injection control circuit 32.

The liquid feed path pressure sensor (pressure detection device) 35 is adapted to detect the pressure of liquid contained in the liquid feed path 15-1. As shown in FIGS. 4 and 5, the liquid feed path pressure sensor 35 is fixed on the upper surface of the ceramic sheet 15f at a position located above the liquid feed path 15-1 with respect to the direction of the Z-axis. The liquid feed path 15-1 has a communication path which extends in the direction of the Z-axis to the lower surface of the ceramic sheet 15f at a position corresponding to that of the liquid feed path pressure sensor 35. Therefore, the ceramic sheet 15f is deformed according to the pressure of liquid contained in the liquid feed path 15-1. The liquid feed path pressure sensor 35 is formed of a piezoelectric element or a piezoresistance element and generates a voltage signal according to the deformation of the ceramic sheet 15f.

Hereinafter, the pressure of liquid contained in the liquid feed path 15-1 and detected by the liquid feed path pressure sensor 35 may be called “detected-liquid-pressure-in-path PS.” The liquid feed path pressure sensor 35 may be a pressure detection device for detecting liquid pressure at a certain location in a liquid path extending from the discharge ports 14c-2 of the solenoid-operated on-off discharge valve 14 to the liquid injection port 15-4a of each of the liquid discharge nozzles 15-4 (one end of each liquid discharge nozzle 15-4 exposed to the liquid injection space 21). In other words, the pressure detection device may be a pressure sensor (a piezoelectric element, a piezoresistance element, or the like) disposed in the liquid inlet 15-5, the chamber 15-2, or the liquid discharge nozzle 15-4. Notably, the expression “to be disposed in the liquid inlet 15-5, the chamber 15-2, or the liquid discharge nozzle 15-4” means being disposed at a position where the pressure of liquid contained in the liquid inlet 15-5, the chamber 15-2, or the liquid discharge nozzle 15-4 is detected.

Furthermore, the liquid feed path pressure sensor 35 may include a low-pass filter for the following purpose: a detection signal is filtered by the low-pass filter so as to obtain a time average of the pressure of liquid contained in the liquid feed path 15-1, and the thus-obtained signal is output to the electronic engine control unit 31 or the like as the detected-liquid-pressure-in-path PS. Alternatively, such filtering may be performed within the electronic engine control unit 31 by software means.

The electronic fuel injection control circuit 32 includes a microcomputer 32a for fuel injection control (hereinafter referred to as the “fuel injection control microcomputer 32a”), a solenoid-operated on-off discharge valve drive circuit section 32b, and a piezoelectric/electrostrictive-element drive circuit section 32c. The fuel injection control microcomputer 32a receives the aforementioned drive voltage signal from the electronic engine control unit 31 and sends a control signal based on the received drive voltage signal to the solenoid-operated on-off discharge valve drive circuit section 32b and the piezoelectric/electrostrictive-element drive circuit section 32c. Notably, the fuel injection control microcomputer 32a inputs the detected-liquid-pressure-in-path PS from the liquid feed path pressure sensor 35 as needed.

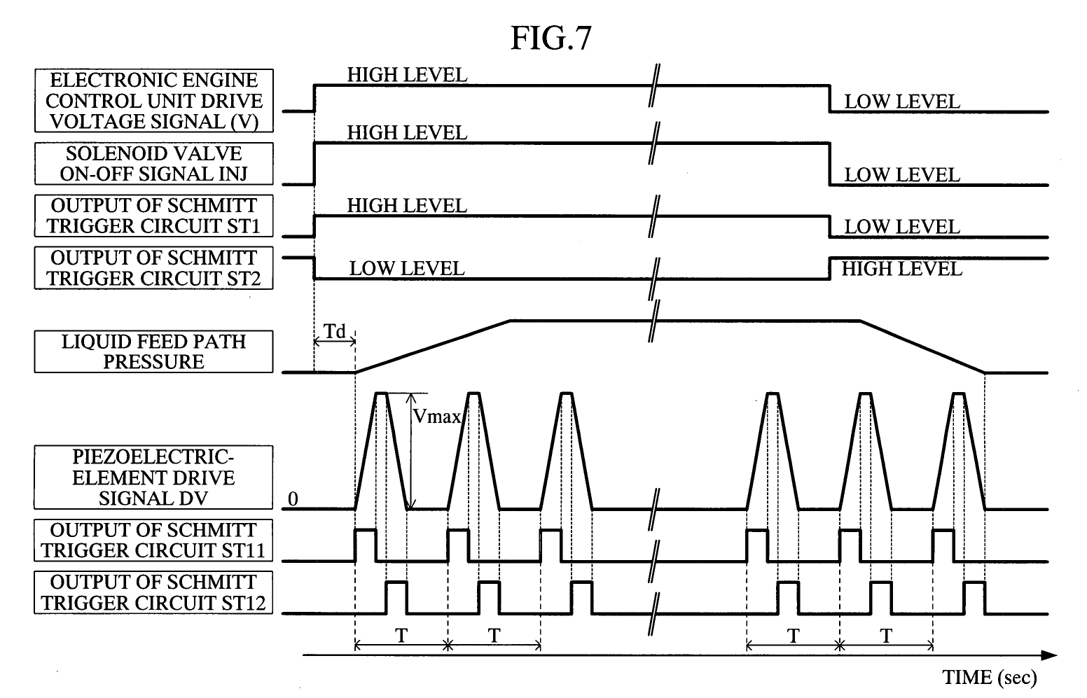

As shown in the timing chart of FIG. 7, the solenoid-operated on-off discharge valve drive circuit section 32b outputs a solenoid valve on-off signal of rectangular wave to an unillustrated solenoid mechanism of the solenoid-operated on-off discharge valve 14. Upon generation of the solenoid valve on-off signal (i.e., when the solenoid valve on-off signal becomes a high-level signal (valve ON signal)), the needle valve 14d of the solenoid-operated on-off discharge valve 14 is moved to open the discharge ports 14c-2, and thus fuel is discharged into the liquid feed path 15-1 from the solenoid-operated on-off discharge valve 14 via the liquid inlet 15-5 of the injection device 15A. By contrast, when generation of the solenoid valve on-off signal is stopped (i.e., when the solenoid valve on-off signal becomes a low-level signal (valve OFF signal)), the needle valve 14d closes the discharge ports 14c-2, and thus discharge of fuel into the liquid feed path 15-1 is stopped.

As shown in FIG. 7, the piezoelectric/electrostrictive-element drive circuit section 32c applies the piezoelectric-element drive signal DV of frequency f (period T=1/f) between unillustrated electrodes of each of the piezoelectric/electrostrictive elements 15g on the basis of a control signal from the fuel injection control microcomputer 32a. The piezoelectric-element drive signal DV has such a waveform as to increase steeply from 0 (V) to a predetermined maximum electric potential Vmax (V), subsequently maintain the maximum electric potential Vmax for only a short period of time, and then decrease steeply toward 0 (V).

The drive frequency f of the piezoelectric-element drive signal DV is set to a frequency, for example near 50 kHz, equal to the resonance frequency (natural frequency) of the injection device 15A, which depends on the structure of the chambers 15-2, the structure of the liquid discharge nozzles 15-4, the nozzle diameter D, the introduction hole diameter d, the shape of a portion of each of the piezoelectric/electrostrictive elements 15g which causes deformation of the ceramic sheet 15f, liquid to be used, and the like.

When a state in which the solenoid valve on-off signal is generated (the solenoid valve on-off signal assumes a high level) continues, the pressure of liquid contained in the liquid feed path 15-1 converges to a constant, high pressure, whereby injection of liquid from the liquid discharge nozzles 15-4 continues. When a state in which the solenoid-operated on-off signal is not generated (the solenoid valve on-off signal assumes a low level) continues, the pressure of liquid contained in the liquid feed path 15-1 converges to a constant, low pressure. At this time, liquid is not injected from the liquid discharge nozzles 15-4.

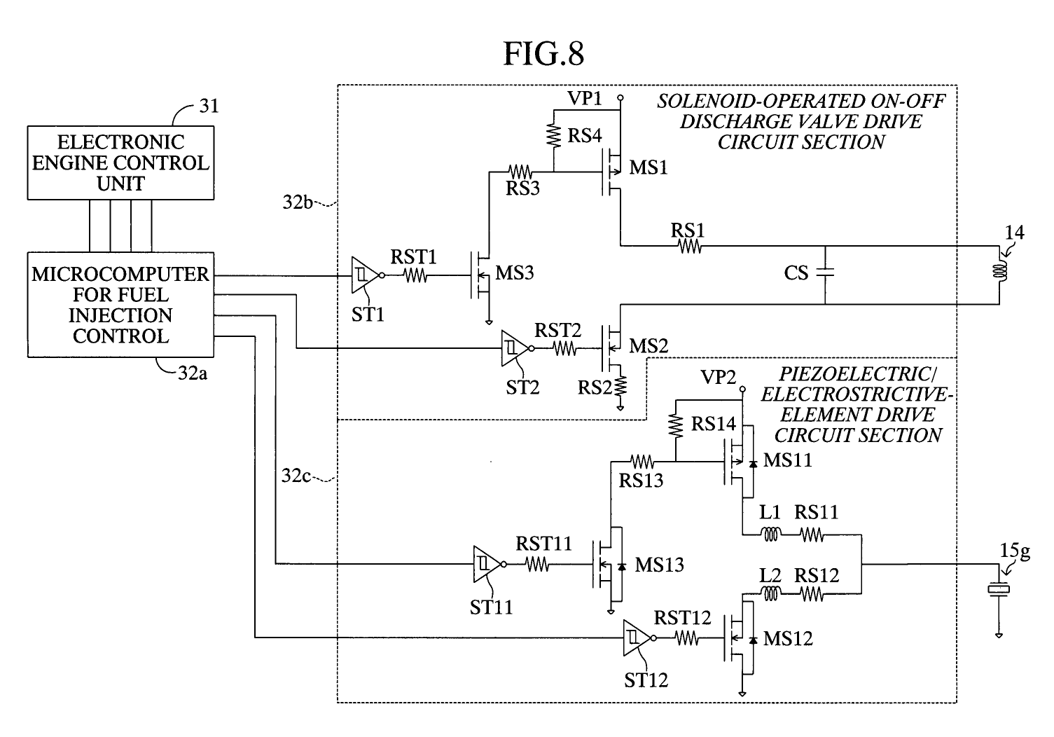

The configuration and action of the above-described solenoid-operated on-off discharge valve drive circuit section 32b and those of the above-described piezoelectric/electrostrictive-element drive circuit section 32c will next be described in detail with reference to FIG. 7 and FIG. 8, which shows electric circuit diagrams of these circuit sections.

As shown in FIG. 8, the solenoid-operated on-off discharge valve drive circuit section 32b includes two Schmitt trigger circuits ST1 and ST2; three field effect transistors (MOS FET) MS1 to MS3; a plurality of resistors RST1, RST2, and RS1 to RS4; and one capacitor CS. Among these resistors, the resistors RST1 and RST2 are output current limiting resistors for the Schmitt trigger circuits ST1 and ST2, respectively.

As shown in FIG. 7, when the electronic engine control unit 31 outputs the drive voltage signal which changes from a low level to a high level, to the fuel injection control microcomputer 32a, the fuel injection control microcomputer 32a outputs a signal (not shown) which changes from a high level to a low level, to the Schmitt trigger circuit ST1. Also, the fuel injection control microcomputer 32a outputs a signal (not shown) which changes from a low level to a high level, to the Schmitt trigger circuit ST2.

This causes the Schmitt trigger circuit ST1 to output a high-level signal. Accordingly, the field effect transistor MS3 turns ON (electrically conductive). As a result, the field effect transistor MS1 also turns ON. Since the Schmitt trigger circuit ST2 outputs a low-level signal, the field effect transistor MS2 turns OFF (electrically nonconductive).

This causes the power supply voltage VP1 to be applied to the capacitor CS and the solenoid-operated on-off discharge valve 14 (the solenoid mechanism thereof), and thus the capacitor CS is charged. At this time, current flows to the solenoid-operated on-off discharge valve 14, and after the elapse of time Td—which is a predetermined delay time (a so-called ineffective injection time) stemming from an inductor component—the needle valve 14d starts to move. As a result, discharge of liquid into the liquid feed path 15-1 from the solenoid-operated on-off discharge valve 14 starts, so that the liquid pressure in the liquid feed path 15-1 starts to rise from a constant, low pressure.

Meanwhile, when the electronic engine control unit 31 sends the drive voltage signal which changes from a high level to a low level, to the fuel injection control microcomputer 32a, the fuel injection control microcomputer 32a outputs a control signal (not shown) which changes from a low level to a high level, to the Schmitt trigger circuit ST1. Also, the fuel injection control microcomputer 32a outputs a control signal (not shown) which changes from a high level to a low level, to the Schmitt trigger circuit ST2.

This causes the Schmitt trigger circuit ST1 to output a low-level signal. Accordingly, the field effect transistor MS3 turns OFF, and thus the field effect transistor MS1 turns OFF. Also, since the Schmitt trigger circuit ST2 outputs a high-level signal, the field effect transistor MS2 turns ON. As a result, the power supply voltage VP1 is not applied to the capacitor CS and the solenoid-operated on-off discharge valve 14 (the solenoid mechanism thereof); and the capacitor CS is grounded via the field effect transistor MS2, whereby charges stored in the capacitor CS are discharged. Thus, application of electricity to the solenoid-operated on-off discharge valve 14 is stopped, and, after the elapse of a predetermined time after the field effect transistor MS2 has turned ON, the needle valve 14d starts to move toward the initial position. Accordingly, the amount of liquid discharged into the liquid feed path 15-1 from the solenoid-operated on-off discharge valve 14 reduces; as a result, liquid pressure in the liquid feed path 15-1 decreases toward the aforementioned constant, low pressure from the aforementioned constant, high pressure.

The above is the action of the solenoid-operated on-off discharge valve drive circuit section 32b. Notably, the capacitor CS functions to maintain voltage to be applied to the solenoid mechanism of the solenoid-operated on-off discharge valve 14 when the power supply voltage VP1 is applied to the solenoid mechanism. Next, the piezoelectric/electrostrictive-element drive circuit section 32c will be described.

As shown in FIG. 8, the piezoelectric/electrostrictive-element drive circuit section 32c includes two Schmitt trigger circuits ST11 and ST12; three field effect transistors (MOS FET) MS11 to MS13; a plurality of resistors RST11, RST12, and RS11 to RS14; and two coils L1 and L2. Among these resistors, the resistors RST11 and RST12 are output current limiting resistors for the Schmitt trigger circuits ST11 and ST12, respectively.

As shown in FIG. 7, when the electronic engine control unit 31 outputs the drive voltage signal (in this case, may be called a “piezoelectric-element activation instruction signal”) which changes from a low level to a high level, to the fuel injection control microcomputer 32a, on the basis of the drive voltage signal, the fuel injection control microcomputer 32a outputs, as a control signal (not shown), a pulse of a constant width (a rectangular wave formed such that voltage drops to 0 (V) from a constant voltage, is then maintained at 0 (V) for a predetermined period of time, and is subsequently restored to the constant voltage) to the Schmitt trigger circuit ST11 every elapse of period T (frequency f=1/T). The fuel injection control microcomputer 32a outputs a similar pulse, as a control signal, to the Schmitt trigger circuit ST12 in such a manner as to slightly lag the control signal sent to the Schmitt trigger circuit ST11.

When a pulse is input to the Schmitt trigger circuit ST11, the Schmitt trigger circuit ST11 outputs a high-level signal. Accordingly, the field effect transistor MS13 turns ON; as a result, the field effect transistor MS11 also turns ON. At this point of time, the Schmitt trigger circuit ST12 outputs a low-level signal; thus, the field effect transistor MS12 remains OFF. Therefore, since the power supply voltage VP2 is applied to the piezoelectric/electrostrictive elements 15g via the coil L1 and the resistor RS11, the piezoelectric/electrostrictive elements 15g cause deformation of the ceramic sheet 15f, whereby the corresponding chambers 15-2 reduce in volume.

Subsequently, the pulse input to the Schmitt trigger circuit ST11 disappears. This causes the Schmitt trigger circuit ST11 to output a low-level signal, and thus the field effect transistors MS13 and MS11 turn OFF. Even at this point of time, no pulse is input to the Schmitt trigger circuit ST12. Therefore, the Schmitt trigger circuit ST12 outputs a low-level signal, and thus the field effect transistor MS12 remains OFF. As a result, the piezoelectric/electrostrictive elements 15g retain stored charges, whereby the electric potential between electrodes of each of the piezoelectric/electrostrictive elements 15g is maintained at the maximum value Vmax.

Subsequently, the fuel injection control microcomputer 32a sends the aforementioned pulse to the Schmitt trigger circuit ST12 only. This causes the Schmitt trigger circuit ST12 to output a high-level signal, and thus the field effect transistor MS12 turns ON. As a result, the piezoelectric/electrostrictive elements 15g are grounded via the resistor RS12, the coil L2, and the field effect transistor MS12, whereby charges stored in the piezoelectric/electrostrictive elements 15g are discharged. Thus, the piezoelectric/electrostrictive elements 15g begin to be restored to the initial shape, whereby the corresponding chambers 15-2 increase in volume.

As mentioned previously, such an action is repeated every elapse of the period T (frequency f=1/T), whereby vibration energy is transmitted to liquid contained in the chambers 15-2. The above is the action of the piezoelectric/electrostrictive-element drive circuit section 32c.

Notably, herein the expression “to generate the solenoid valve on-off signal” means applying the power supply voltage VP1 to the solenoid-operated valve 14 via the field effect transistor MS1 and the like; and the expression “to stop generation of the solenoid valve on-off signal” means stopping application of the power supply voltage VP1 to the solenoid-operated valve 14. The expression “to generate the piezoelectric-element drive signal DV” means performing charge and discharge of the piezoelectric/electrostrictive elements 15g at the above-mentioned frequency f (period T); and the expression “to stop generation of the piezoelectric-element drive signal DV” means stopping the above-described charge and discharge repeatedly performed on the piezoelectric/electrostrictive elements 15g (i.e., it means starting continuous grounding of the piezoelectric/electrostrictive elements 15g via the field effect transistor MS12).

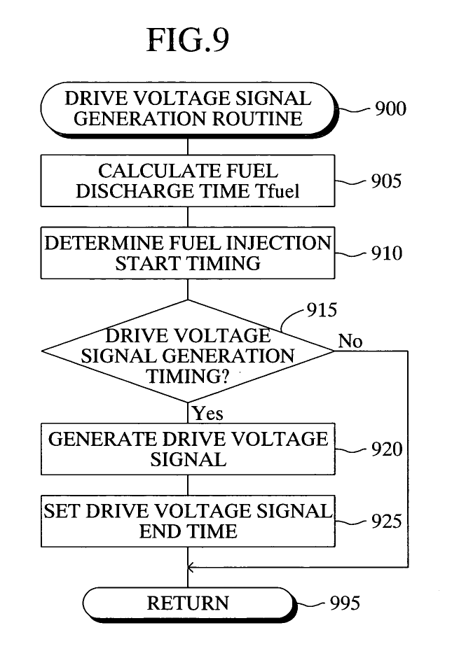

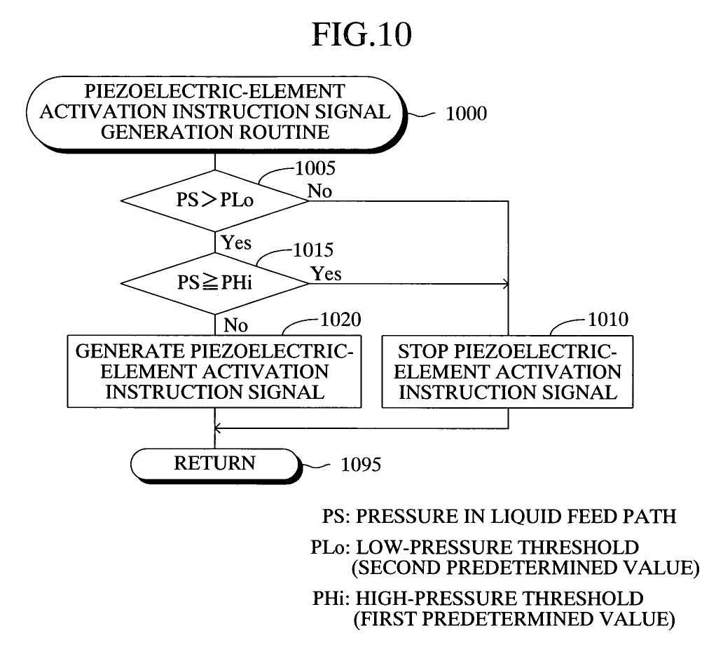

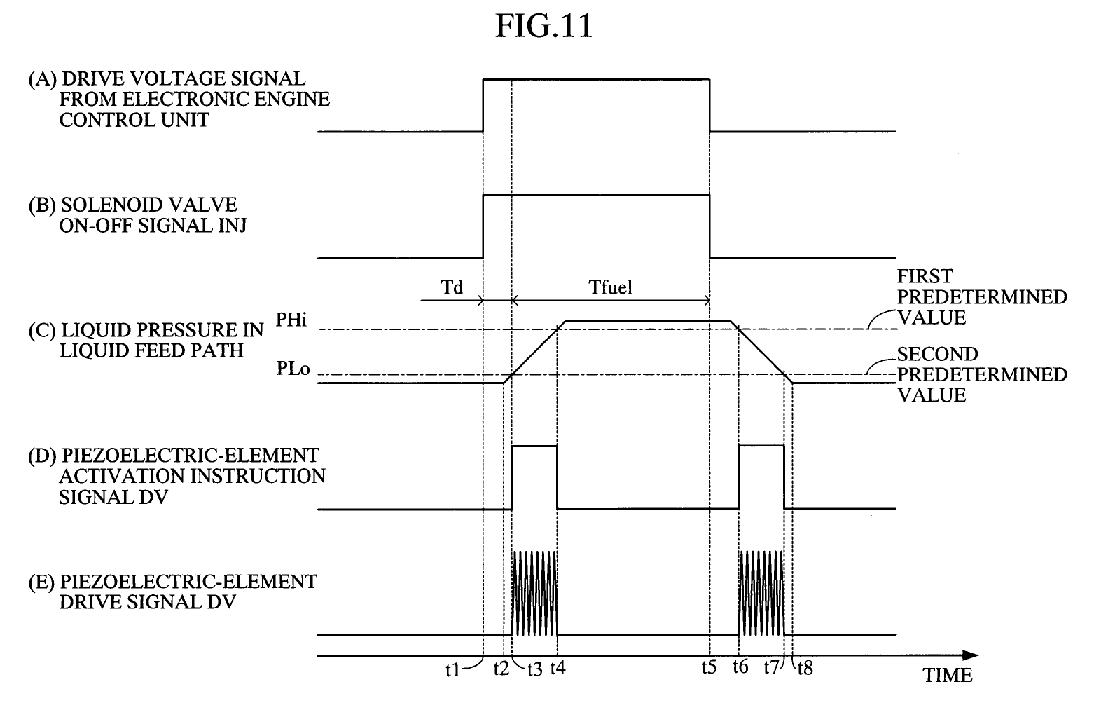

Next, the action of the liquid injection apparatus 10 having the above-described configuration will be described with reference to the flowcharts of FIGS. 9 and 10 and the timing chart of FIG. 11. The electronic engine control unit 31 repeatedly executes the drive voltage signal generation routine of FIG. 9 every elapse of a predetermined time. Accordingly, when predetermined timing is reached, the electronic engine control unit 31 starts processing from Step 900 and proceeds to Step 905. At Step 905, on the basis of engine operation conditions, such as engine speed N and intake pipe pressure P, the electronic engine control unit 31 determines time (fuel discharge time Tfuel) during which the solenoid-operated on-off discharge valve 14 is opened to thereby inject fuel.

Next, the electronic engine control unit 31 proceeds to Step 910 and determines the timing of starting discharge of fuel (fuel injection start timing). Fuel injection start timing is determined in terms of a crank angle before the top dead center of intake of an engine. On the basis of engine speed N and current time indicated by the timer of the electronic engine control unit 31, the crank angle is converted to time as indicated by the timer. Herein, fuel injection start timing is time t3 in FIG. 11.

Next, at Step 915, the electronic engine control unit 31 determines whether or not the current point of time is the timing of generating the drive voltage signal. This drive voltage generation timing is time t1, which is a slight time (a so-called ineffective injection time Td, which is a delay time stemming from inductance of the solenoid mechanism of the solenoid-operated on-off discharge valve 14) before t3—fuel injection start timing. When the current point of time is not drive voltage generation timing, the electronic engine control unit 31 forms a “No” judgment at Step 915 and proceeds to Step 995, thereby ending the present routine for the time being.

Meanwhile, when the current point of time is drive voltage generation timing, the electronic engine control unit 31 forms a “Yes” judgment at Step 915 and proceeds to Step 920, where the unit 31 generates the drive voltage signal. Then, at Step 925, the electronic engine control unit 31 sets a time (time t5 in the example of FIG. 11) obtained through adding the ineffective injection time Td and the fuel discharge time Tfuel to a current time, in an unillustrated register as a drive voltage signal end time. Then, proceeding to Step 995, the electronic engine control unit 31 ends the present routine for the time being. When a time indicated by the timer of the electronic engine control unit 31 coincides with the drive voltage signal end time, the electronic engine control unit 31 ends generation of the drive voltage signal. The above-described action causes the drive voltage signal of high level to be sent to the fuel injection control microcomputer 32a during the period of time ranging from t1 to t5.

Upon reception of the drive voltage signal at time t1 from the electronic engine control unit 31, the fuel injection control microcomputer 32a sends the aforementioned control signal to the solenoid-operated on-off discharge valve drive circuit section 32b. As a result, since the solenoid-operated on-off discharge valve drive circuit section 32b issues the solenoid valve on-off signal (a high-level signal) to the solenoid-operated on-off discharge valve 14, when time t2 slightly after time t1 is reached, the needle valve 14d starts to move, thereby starting to open the discharge ports 14c-2.

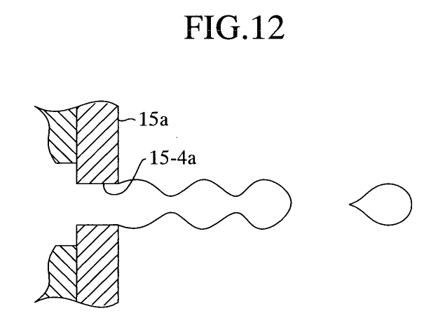

This causes start of discharge/feed of fuel contained in the fuel path 14b into the liquid feed path 15-1 of the injection device 15A from the discharge ports 14c-2 via the closed cylindrical space of the sleeve 15D and the liquid inlet 15-5 of the injection device 15A. As a result, as shown in FIG. 11(C), the pressure of liquid contained in the liquid feed path 15-1 starts to rise at time t2. When, after elapse of the ineffective injection time Td, time t3 is reached, the pressure of liquid contained in the liquid feed path 15-1 becomes equal to or higher than a low-pressure threshold (second predetermined value) PLo. Thus, as shown in FIG. 12, fuel is extruded (injected) from the end face of each of the liquid injection ports 15-4a toward the liquid injection space 21 in the intake pipe 20.

The electronic engine control unit 31 also repeatedly executes the piezoelectric-element activation instruction signal generation routine of FIG. 10 every elapse of a predetermined time. Accordingly, when predetermined timing is reached, the electronic engine control unit 31 starts processing from Step 1000 and proceeds to Step 1005. At Step 1005, the electronic engine control unit 31 judges whether or not the detected-liquid-pressure-in-path PS detected by the liquid feed path pressure sensor 35 is higher than the low-pressure threshold PLo. As mentioned previously, the low-pressure threshold PLo is the minimum liquid pressure in the liquid feed path 15-1 (accordingly, the minimum liquid pressure in the chambers 15-2) required for injection of fuel into the fuel injection space 21, and is very close to “0.” Notably, the low-pressure threshold PLo may be “0.”

When time t1 is not reached, and the drive voltage signal is not generated, the pressure of liquid contained in the liquid feed path 15-1 is a constant, low pressure and is lower than the low-pressure threshold PLo. Accordingly, the electronic engine control unit 31 forms a “No” judgment at Step 1005 and proceeds to Step 1010. At Step 1010, the electronic engine control unit 31 stops generation of the piezoelectric-element activation instruction signal and proceeds to Step 1095, thereby ending the present routine for the time being. Notably, at this point of time, the piezoelectric-element activation instruction signal is not generated; therefore, the process of Step 1010 is a verification process for preventing generation of the piezoelectric-element activation instruction signal.

Subsequently, at time t1, the drive voltage signal is generated. At and after time t3, the pressure PS in the liquid feed path 15-1 becomes higher than the low-pressure threshold PLo. Thus, when the electronic engine control unit 31 proceeds to Step 1005, the unit 31 forms a “Yes” judgment and proceeds to Step 1015. At Step 1015, the electronic engine control unit 31 judges whether the detected-liquid-pressure-in-path PS is equal to or higher than a high-pressure threshold PHi (first predetermined value). The high-pressure threshold PHi is a value slightly lower than or equal to the aforementioned constant, high pressure (the pressure of liquid contained in the liquid feed path 15-1 as measured when the state of generation of the solenoid valve on-off signal continues).

This point of time (immediately after time t3) is when the pressure PS in the liquid feed path 15-1 has just exceeded the low-pressure threshold PLo and is still lower than the high-pressure threshold PHi. Accordingly, the electronic engine control unit 31 forms a “No” judgment at Step 1015 and proceeds to Step 1020. At Step 1020, the electronic engine control unit 31 generates the piezoelectric-element activation instruction signal. Subsequently, the electronic engine control unit 31 proceeds to Step 1095 and ends the present routine for the time being.

This causes the fuel injection control microcomputer 32a to receive the piezoelectric-element activation instruction signal. Accordingly, the fuel injection control microcomputer 32a sends a control signal to the piezoelectric/electrostrictive-element drive circuit section 32c and causes the drive circuit section 32c to apply, from time t3, the piezoelectric-element drive signal DV of frequency f between the electrodes of each of the piezoelectric/electrostrictive elements 15g.

As a result, as shown in FIG. 12, since vibration energy induced by the activation of the piezoelectric/electrostrictive elements 15g is applied to fuel contained in the corresponding chambers 15-2, constricted portions are formed on the fuel which is extruded toward the liquid injection space 21 from the end face of each of the liquid injection ports 15-4a. Thus, a leading end portion of the fuel leaves the remaining portion of the fuel while being torn off at its constricted portion. As a result, uniformly and finely atomized fuel is injected into the intake pipe 20.

Subsequently, when, after the elapse of time, time t4 is reached, the pressure in the liquid feed path 15-1 becomes equal to or higher than the high-pressure threshold PHi. Thus, the electronic engine control unit 31 forms a “Yes” judgment at Steps 1005 and 1015 and proceeds to Step 1010. At Step 1010, the electronic engine control unit 31 stops generation of the piezoelectric-element activation instruction signal. As a result, the fuel injection control microcomputer 32a causes the piezoelectric/electrostrictive-element drive circuit section 32c to stop generation of the piezoelectric-element drive signal DV.

Next, when time t5 is reached, as mentioned previously, the drive voltage signal is caused to disappear, and thus the solenoid valve on-off signal disappears. As a result, when a predetermined time elapses, discharge of the capacitor CS progresses. Thus the solenoid-operated on-off discharge valve 14 starts to close. Accordingly, the pressure in the liquid feed path 15-1 starts to decrease toward “0” from a value equal to or higher than the high-pressure threshold PHi. At time t6, the pressure becomes equal to or lower than the high-pressure threshold PHi. At this time, when the electronic engine control unit 31 executes the routine of FIG. 10, the unit 31 forms a “Yes” judgment at Step 1005 and forms a “No” judgment at Step 1015. Accordingly, the electronic engine control unit 31 proceeds to Step 1020 and again generates the piezoelectric-element activation instruction signal.

As a result, since the fuel injection control microcomputer 32a causes the piezoelectric/electrostrictive-element drive circuit section 32c to generate the piezoelectric-element drive signal DV, vibration energy induced by the activation of the piezoelectric/electrostrictive elements 15g is again applied to fuel contained in the corresponding chambers 15-2, whereby atomization of fuel is performed.

Subsequently, when time t7 is reached, the pressure in the liquid feed path 15-1 drops to the low-pressure threshold PLo or lower. Thus, when the electronic engine control unit 31 executes the routine of FIG. 10, the unit 31 forms a “No” judgment at Step 1005 and proceeds to Step 1010. At Step 1010, the electronic engine control unit 31 stops generation of the piezoelectric-element activation instruction signal. As a result, the fuel injection control microcomputer 32a causes the piezoelectric/electrostrictive-element drive circuit section 32c to stop generation of the piezoelectric-element drive signal DV. Then, at time t8, the pressure in the liquid feed path 15-1 becomes “0” (a constant, low pressure).

The above is the action of the liquid injection apparatus 10 associated with a single fuel injection. As described above, the liquid injection apparatus 10 (electrical control unit 30) changes the piezoelectric-element drive signal DV on the basis of the detected-liquid-pressure-in-path PS. Specifically, in the liquid injection apparatus 10, when the detected-liquid-pressure-in-path PS is in the process of increasing or decreasing (between time t3 and time t4 or between time t6 and time t7) because of generation of the solenoid valve on-off signal or stoppage of generation of the solenoid valve on-off signal, the piezoelectric-element drive signal DV is generated to thereby activate the piezoelectric/electrostrictive elements 15g; and when the detected-liquid-pressure-in-path PS is a constant, low pressure (a pressure lower than the low-pressure threshold PLo) (before time t3 and after time t7) due to disappearance of the solenoid valve on-off signal, the piezoelectric-element drive signal DV is not generated to thereby deactivate the piezoelectric/electrostrictive elements 15g. Also, in the liquid injection apparatus 10, during a period in which the detected-liquid-pressure-in-path PS is a constant, high pressure, which is equal to or higher than the high-pressure threshold PHi, the piezoelectric-element drive signal DV is not generated to thereby deactivate the piezoelectric/electrostrictive elements 15g.

As described above, in the liquid injection apparatus 10, liquid pressurized by the pressurizing device (pressure pump 11) is discharged into the injection device 15A from the solenoid-operated on-off discharge valve 14. The liquid is atomized through volume change of the chambers 15-2 of the injection device 15A and is then injected from the corresponding liquid discharge nozzles 15-4. Since pressure required for injection of liquid into the liquid injection space 21 is generated by the pressurizing device (pressure pump 11), even when atmospheric conditions (e.g., pressure and temperature) within the liquid injection space 21 fluctuate wildly due to fluctuations in, for example, operating conditions of a machine to which the liquid injection apparatus 10 is applied, the liquid can be injected and fed stably in the form of expected fine droplets.

Furthermore, at least when the pressure of liquid contained in the liquid feed path is in the process of increasing due to generation of the solenoid valve on-off signal (the time between t3 and t4 in which the detected-liquid-pressure-in-path PS is in the process of increasing) or when the pressure of liquid contained in the liquid feed path is in the process of decreasing due to stoppage of generation of the solenoid valve on-off signal (the time between t6 and t7 in which the detected-liquid-pressure-in-path PS is in the process of lowering), the electrical control unit 30 activates piezoelectric/electrostrictive elements 15g. Therefore, even in the case where the injection velocity of liquid is not high enough to sufficiently atomize the liquid because of the relatively low injection pressure of the liquid at the time when the pressure of the liquid is in the process of increasing or decreasing, the liquid can be appropriately atomized through volume change of the chambers 15-2 effected by activation of the corresponding piezoelectric/electrostrictive elements 15g.

When the pressure of liquid contained in the liquid feed path 15-1 is a constant, low pressure because of disappearance of the solenoid valve on-off signal; i.e., when liquid is never injected into the liquid injection space 21 from the liquid discharge nozzles 15-4 of the injection device 15A, the injection device 15A does not need to perform the action of atomizing liquid. Thus, the electrical control unit 30 is configured such that, when the detected-liquid-pressure-in-path PS is equal to or lower than the low-pressure threshold PLo, the unit 30 does not generate the piezoelectric-element drive signal DV. This allows the liquid injection apparatus 10 to avoid waste of electricity.

Furthermore, in the liquid injection apparatus 10, when the detected-liquid-pressure-in-path PS is a high pressure equal to or higher than the high-pressure threshold PHi, the piezoelectric-element drive signal DV is not generated to thereby deactivate the piezoelectric/electrostrictive elements 15g.

When the pressure of liquid contained in the liquid feed path 15-1 increases to a sufficiently high pressure (the aforementioned constant, high pressure in excess of the high-pressure threshold PHi) due to generation of the solenoid valve on-off signal, the velocity of liquid injected into the liquid injection space 21 from the liquid discharge nozzles 15-4 of the injection device 15A (the injection velocity, or the travel velocity of a liquid column) becomes sufficiently high, whereby the liquid assumes the form of droplets of a relatively small size by virtue of surface tension. Therefore, in such a case (from time t4 to time t6), by means of avoidance of generation of the piezoelectric-element drive signal DV, the liquid injection apparatus 10 can reduce its electrical consumption.

Notably, preferably, in the above-described embodiment, when Q (cc/min) represents the amount of liquid to be discharged per unit time (discharge flow rate) from the solenoid-operated on-off discharge valve 14, and V (cc) represents the volume of a liquid path formed between the solenoid-operated on-off discharge valve 14 and the distal ends of the discharge nozzles 15-4 of the injection device 15A, their ratio (V/Q) is 0.03 or less.

Herein, the volume V is the sum total of the volume of the closed cylindrical space of the sleeve 15D, the volume of the liquid inlet 15-5, the volume of the liquid feed path 15-1, the volume of the chambers 15-2, the volume of the liquid introduction holes 15-3, and the volume of the liquid discharge nozzles 15-4.

Also, preferably, a time when the solenoid valve on-off signal assumes a high level is set in such a manner as to only fall within a time when the intake valve 22 of an internal combustion engine is opened. Through employment of this feature, when fuel injected from the liquid injection apparatus 10 reaches the intake valve 22, the intake valve 22 is open, whereby the fuel can be directly taken in a cylinder without adhesion to, for example, the back surface of the intake valve 22, and the fuel injected in an atomized condition is directly taken in the cylinder. Since the injected fuel does not adhere to the intake valve 22 and the wall surface of the intake pipe 20, the fuel economy of the internal combustion engine can be enhanced, and the amount of an unburnt gas contained in exhaust can be reduced.

Notably, preferably, the velocity of fuel injected in an atomized condition from the liquid discharge nozzles 15-4 (the velocity of liquid droplets or atomized droplets) is varied according to the amount of lift of the intake valve 22 and/or the intake air velocity (wind velocity) within the intake pipe. Through employment of this feature, fuel injected in an atomized condition become more unlikely to adhere to a wall surface, whereby the fuel can be directly taken in a cylinder. The velocity of fuel injected in an atomized condition from the liquid discharge nozzles 15-4 can be changed through changing the pressure of fuel (fuel pressure) to be fed to the solenoid-operated on-off discharge valve 14. The fuel pressure can be changed through changing the regulation pressure of the pressure regulator 13, or when the pressure regulator 13 is not provided, the fuel pressure can be changed through changing the discharge pressure of the pressure pump 11.

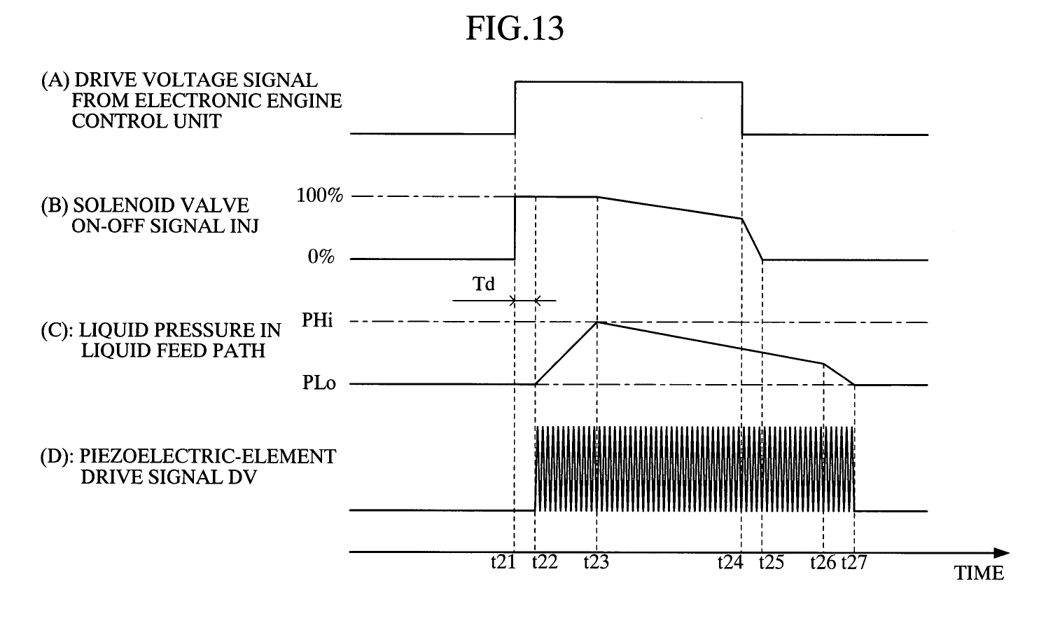

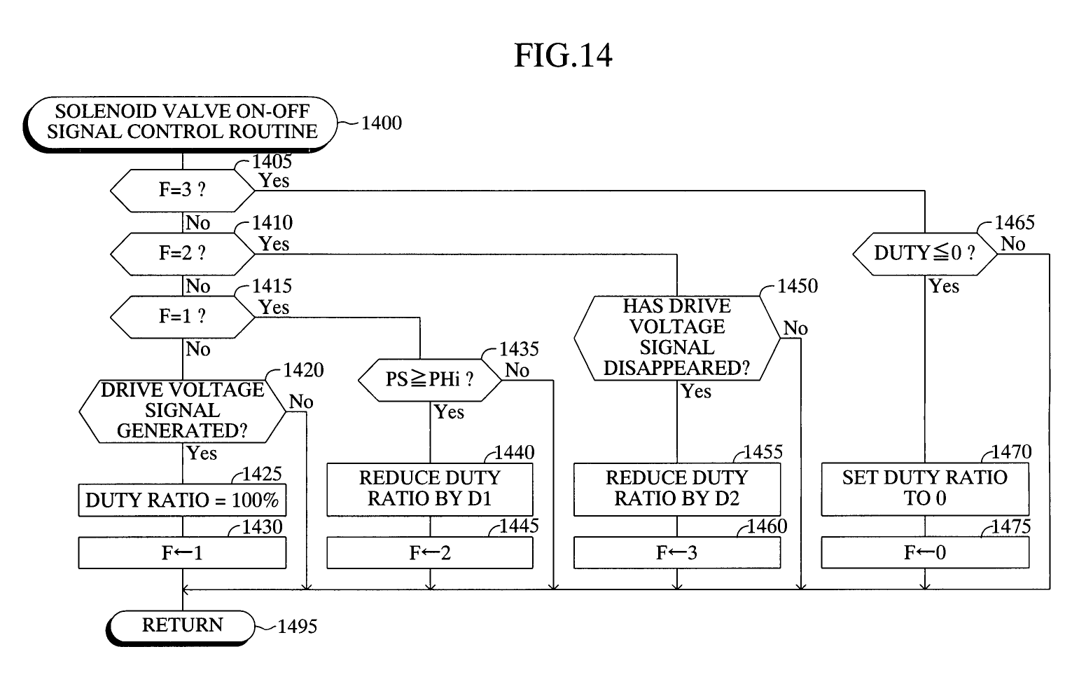

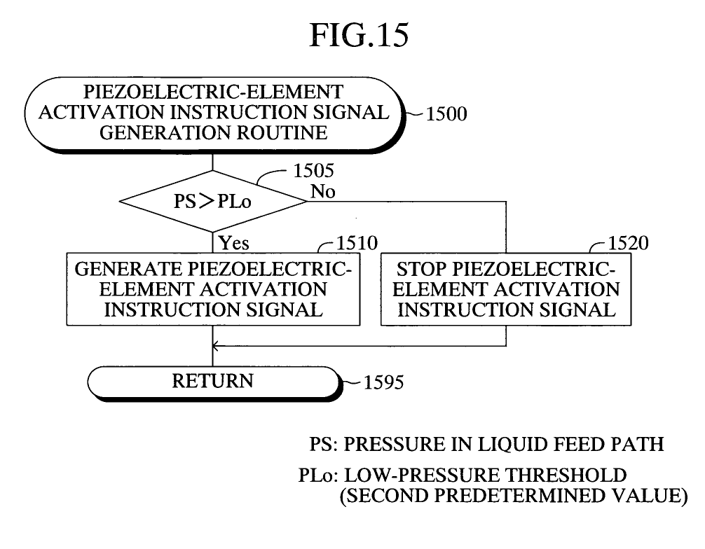

Next, a liquid injection apparatus 10 according to a second embodiment of the present invention will be described. The liquid injection apparatus 10 according to the second embodiment differs from the liquid injection apparatus 10 according to the first embodiment only in a pattern for generating the solenoid valve on-off signal and the piezoelectric-element drive signal DV. Thus, while the main focus is placed on the above point of difference, the second embodiment will next be described with reference to the timing chart of FIG. 13 and the flowcharts of FIGS. 14 and 15. Notably, FIG. 13(B) shows the duty ratio (or average current) of the solenoid valve on-off signal, which will be described later.

In the second embodiment, when the pressure of liquid contained in the liquid feed path 15-1 is higher than the aforementioned constant, low pressure (in this example, a pressure higher than the low-pressure threshold PLo set to “0”) as a result of opening of the solenoid-operated on-off discharge valve 14; in other words, when liquid is possibly injected from the liquid discharge nozzles 15-4, generation of the piezoelectric-element drive signal DV is continued (see a portion of the timing chart ranging from time t22 to time t27 in FIG. 13).

The solenoid valve on-off signal is generated such that the pressure of liquid contained in the liquid feed path 15-1 increases steeply (see a portion of the timing chart ranging from time t22 to time t23) immediately after start of generation of the solenoid valve on-off signal and subsequently decreases gradually (slowly) at a pressure change rate whose absolute value is smaller than that of a pressure change rate at the time of the increase of the liquid pressure (see a portion of the timing chart ranging from time t23 to time t27).

More specifically, when, as shown in FIG. 13(A), the drive voltage signal from the electronic engine control unit 31 arises at time t21, the fuel injection control microcomputer 32a causes the solenoid-operated on-off discharge valve drive circuit section 32b to generate the solenoid valve on-off signal. At this time, the fuel injection control microcomputer 32a generates respective control signals to the Schmitt trigger circuits ST1 and ST2 such that the field effect transistor MS1 of the solenoid-operated on-off discharge valve drive circuit section 32b maintains the ON state, while the field effect transistor MS2 maintains the OFF state. In other words, a pulsing voltage which changes between 0 (V) and the power supply voltage VP1 (V) in the predetermined period Tp and whose duty ratio (=(time during which VP1 (V) is maintained)/Tp) is 100% is applied to the solenoid-operated on-off discharge valve 14.

This causes the needle valve 14d of the solenoid-operated on-off discharge valve 14 to start to move toward its maximum movement position at time t22, which is reached after the elapse of the ineffective injection time Td, and thus the discharge ports 14c-2 start to be opened. Accordingly, as shown in FIG. 13(C), the pressure of liquid contained in the liquid feed path 15-1 starts to steeply rise at a predetermined increase rate α1. At and after time t22, since the detected-liquid-pressure-in-path PS becomes higher than the low-pressure threshold PLo, the fuel injection control microcomputer 32a causes the piezoelectric/electrostrictive-element drive circuit section 32c to generate the piezoelectric-element drive signal DV.

Subsequently, at time t23 when the pressure of liquid contained in the liquid feed path 15-1 becomes the aforementioned constant, high pressure (in this example, at a time when the detected-liquid-pressure-in-path PS becomes equal to or higher than the high-pressure threshold PHi set equal to the aforementioned constant, high pressure), the fuel injection control microcomputer 32a gradually reduces the duty ratio of the solenoid valve on-off signal applied to the solenoid-operated on-off discharge valve 14. As a result, since the needle valve 14d of the solenoid-operated on-off discharge valve 14 starts to gradually move toward the initial position, the substantial opening area of the discharge ports 14c-2 gradually reduces. Accordingly, the pressure of liquid contained in the liquid feed path 15-1 starts to decrease at a predetermined reduction rate α2. At this time, the absolute value of the reduction rate α2 is smaller than that of the increase rate α1.

Subsequently, at time t24, because of disappearance of the drive voltage signal from the electronic engine control unit 31, the fuel injection control microcomputer 32a steeply reduces the aforementioned duty ratio of the solenoid valve on-off signal applied to the solenoid-operated on-off discharge valve 14. Then, at time t25 when the duty ratio of the solenoid valve on-off signal applied to the solenoid-operated on-off discharge valve 14 becomes 0%, the fuel injection control microcomputer 32a stops generation of the solenoid valve on-off signal.

As a result, from time t24, the needle valve 14d of the solenoid-operated on-off discharge valve 14 moves faster toward the initial position, and thus the substantial opening area of the discharge ports 14c-2 steeply reduces. Accordingly, from time t26 subsequent to time t24, the pressure of liquid contained in the liquid feed path 15-1 starts to steeply lower at a predetermined reduction rate α3 whose absolute value is greater than that of the reduction rate α2. At time t27, the pressure of liquid contained in the liquid feed path 15-1 becomes the aforementioned constant, low pressure. Notably, a time ranging from time t24 to time t26 is a time caused by an operation lag of the needle valve 14d.

Meanwhile, from time t22, the fuel injection control microcomputer 32a continues generation of the piezoelectric-element drive signal DV. At time t27 when the detected-liquid-pressure-in-path PS becomes equal to or lower than the low-pressure threshold PLo, the fuel injection control microcomputer 32a stops generation of the piezoelectric-element drive signal DV.

In order to perform the above control, the electronic engine control unit 31 executes the previously-described drive voltage signal generation routine as represented by the flowchart of FIG. 9. The fuel injection control microcomputer 32a executes the solenoid valve on-off signal control routine as represented by the flowchart of FIG. 14 every elapse of a predetermined time. This routine will be briefly described. Flag F indicates the state of the solenoid valve on-off signal. When the duty ratio of the solenoid valve on-off signal is set to 0% (i.e., when the solenoid valve on-off signal is not generated), the flag F has the value “0” at Step 1475; when the duty ratio of the solenoid-operated on-off signal is set to 100%, the flag F has the value “1” at Step 1430; when the duty ratio of the solenoid valve on-off signal is reduced by a positive value D1 per a predetermined time, the flag F has the value “2” at Step 1445; and when the duty ratio of the solenoid valve on-off signal is reduced by a value D2 greater than the value D1, the flag F has the value “3” at Step 1460.

Accordingly, when the solenoid valve on-off signal is not generated, the flag F has the value “0.” Thus, the fuel injection control microcomputer 32a forms a “No” judgment at all of Steps 1405, 1410, and 1415, where the microcomputer 32a judges whether or not the value of the flag F is “3,” “2,” and “1,” respectively, and proceeds to Step 1420. At Step 1420, the fuel injection control microcomputer 32a monitors whether or not the drive voltage signal is generated. Thus, when the electronic engine control unit 31 generates the drive voltage signal, the fuel injection control microcomputer 32a forms a “Yes” judgment at Step 1420 and proceeds to Step 1425. At Step 1425, the fuel injection control microcomputer 32a sets the duty ratio to 100%. Accordingly, the pressure of liquid contained in the liquid feed path 15-1 steeply increases at the predetermined increase rate α1.

At this time, since the value of the flag F becomes 1 (Step 1430), the fuel injection control microcomputer 32a forms a “No” judgment at Steps 1405 and 1410 and a “Yes” judgment at Step 1415 and proceeds to Step 1435. At Step 1435, the fuel injection control microcomputer 32a monitors whether or not the detected-liquid-pressure-in-path PS is equal to or higher than the high-pressure threshold PHi. When the detected-liquid-pressure-in-path PS becomes equal to or higher than the high-pressure threshold PHi, the fuel injection control microcomputer 32a forms a “Yes” judgment at Step 1435 and proceeds to Step 1440. At Step 1440, the fuel injection control microcomputer 32a reduces the duty ratio of the solenoid valve on-off signal by the value D1. Accordingly, the pressure of liquid contained in the liquid feed path 15-1 decreases at the predetermined change rate α2.

At this time, since the value of the flag F becomes 2 (Step 1445), the fuel injection control microcomputer 32a forms a “No” judgment at Step 1405 and a “Yes” judgment at Step 1410 and proceeds to Step 1450. At Step 1450, the fuel injection control microcomputer 32a monitors whether or not the drive voltage signal has disappeared. When the drive voltage signal is judged to have disappeared, the fuel injection control microcomputer 32a forms a “Yes” judgment at Step 1450 and proceeds to Step 1455. At Step 1455, the fuel injection control microcomputer 32a reduces the duty ratio of the solenoid valve on-off signal by the value D2 greater than the value D1. Accordingly, the pressure of liquid contained in the liquid feed path 15-1 decreases at the predetermined change rate α3.

At this time, since the value of the flag F becomes 3 (Step 1460), the fuel injection control microcomputer 32a forms a “Yes” judgment at Step 1405 and proceeds to Step 1465. At Step 1465, the fuel injection control microcomputer 32a monitors whether or not the duty ratio of the solenoid valve on-off signal is “0” or less. When the duty ratio of the solenoid valve on-off signal becomes “0” or less, the fuel injection control microcomputer 32a forms a “Yes” judgment at Step 1465 and proceeds to Step 1470. At Step 1470, the fuel injection control microcomputer 32a sets the duty ratio of the solenoid valve on-off signal to “0.” Then, at Step 1475, the fuel injection control microcomputer 32a returns the value of the flag F to “0.” Through execution of the above routine, the duty ratio of the solenoid valve on-off signal is controlled as mentioned previously.

Also, the fuel injection control microcomputer 32a executes the piezoelectric-element activation instruction generation routine as represented by the flowchart of FIG. 15 every elapse of a predetermined time. This routine will be briefly described. When the detected-liquid-pressure-in-path PS becomes higher than the low-pressure threshold PLo, the fuel injection control microcomputer 32a forms a “Yes” judgment at Step 1505 and proceeds to Step 1510. At Step 1510, the fuel injection control microcomputer 32a generates the piezoelectric-element activation instruction signal (the aforementioned control signal) to thereby generate the piezoelectric-element drive signal DV. By contrast, when the detected-liquid-pressure-in-path PS becomes equal to or lower than the low-pressure threshold PLo, the fuel injection control microcomputer 32a forms a “No” judgment at Step 1505 and proceeds to Step 1520. At Step 1520, the fuel injection control microcomputer 32a stops generation of the piezoelectric-element activation instruction signal, whereby the piezoelectric-element drive signal DV disappears.

As described above, in the liquid injection apparatus 10 according to the second embodiment, when the detected-liquid-pressure-in-path PS is higher than the constant, low pressure, the piezoelectric-element drive signal DV is generated (time t22 to time t27). Furthermore, the liquid injection apparatus 10 operates in the following manner. Immediately after start of generation of the solenoid valve on-off signal (time t22 to time t23), the pressure of liquid contained in the liquid feed path 15-1 is increased at the pressure change rate α1. Subsequently, when the pressure PS of liquid contained in the liquid feed path 15-1 reaches the constant, high pressure PHi, the solenoid valve on-off signal is generated so as to gradually decrease the pressure of liquid contained in the liquid feed path 15-1 at the pressure change rate α2 whose absolute value (|α2|) is smaller than that (|α1|) of the pressure change rate α1 (time t23 to time t26).

According to the present embodiment, since, immediately after start of generation of the solenoid valve on-off signal, the pressure of liquid contained in the liquid feed path 15-1 steeply increases, the generation of the solenoid valve on-off signal leads to immediate start of injection of liquid droplets. Subsequently, the pressure of liquid contained in the liquid feed path 15-1 continues to decrease in a relatively gradual manner (at reduction rate α2). Therefore, the velocity of a preceding injected liquid droplet is higher than that of a subsequent injected liquid droplet, thereby reducing the possibility that liquid droplets injected from each of the liquid discharge nozzles 15-4 collide within the liquid injection space 21 to form a liquid droplet of a greater size.

In other words, the present embodiment is configured in such a manner as to change the solenoid valve on-off signal on the basis of the liquid pressure detected by the pressure detection device. Specifically, according to the present embodiment, a point of time when the pressure of liquid contained in the liquid feed path reaches near maximum pressure is detected through detection of whether or not the detected-liquid-pressure-in-path PS is equal to or higher than the high-pressure threshold PHi. Upon detection of that point of time, the solenoid valve on-off signal is changed such that, from that point of time on, the pressure of liquid contained in the liquid feed path decreases in a relatively gradual manner. Therefore, it is possible to prevent the liquid contained in the liquid feed path from remaining at near maximum pressure (a pressure near the high-pressure threshold PHi) for a long period of time, thereby ensuring avoidance of collision of liquid droplets.

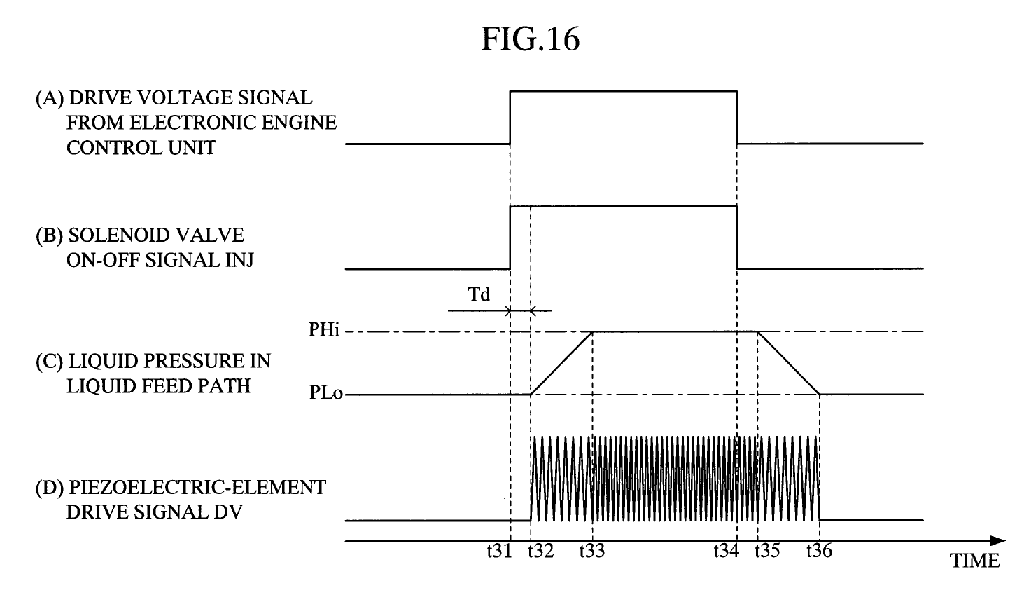

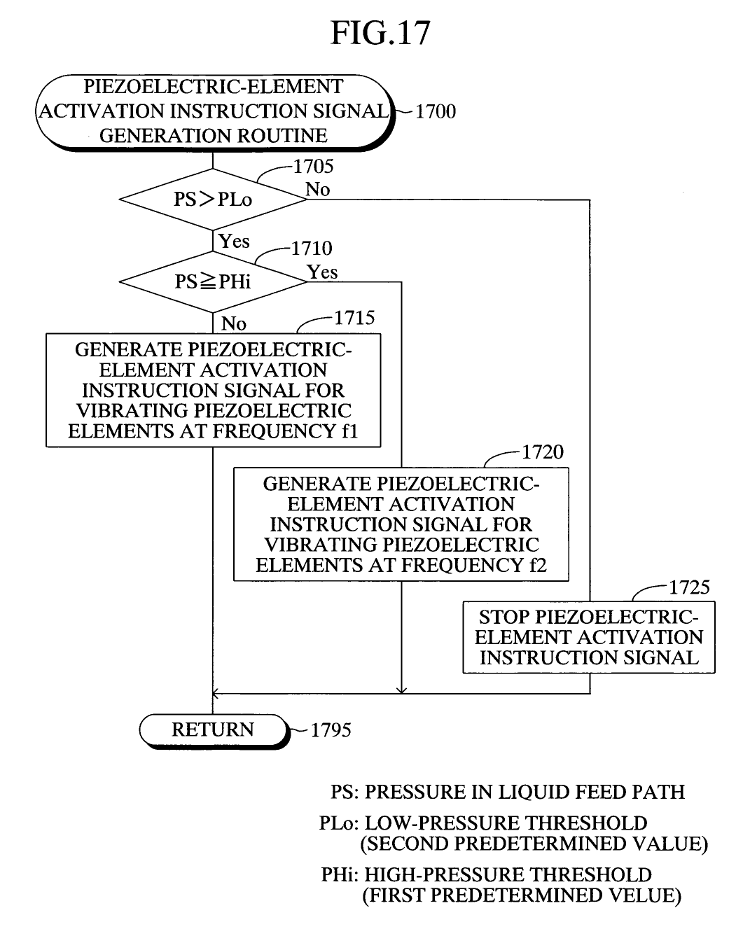

Next, a liquid injection apparatus 10 according to a third embodiment of the present invention will be described. The liquid injection apparatus 10 according to the third embodiment differs from the liquid injection apparatus 10 according to the first embodiment only in a pattern for generating the solenoid valve on-off signal and the piezoelectric-element drive signal DV. Thus, while the main focus is place on the above point of difference, the third embodiment will next be described with reference to the timing chart of FIG. 16 and the flowchart of FIG. 17.

In the third embodiment, when the pressure of liquid contained in the liquid feed path 15-1 is in the process of increasing or decreasing as a result of opening and closing, respectively, of the solenoid-operated on-off discharge valve 14, the frequency f of the piezoelectric-element drive signal DV is set lower than that when the liquid pressure is the aforementioned constant, high pressure. In other words, when the pressure of liquid contained in the liquid feed path 15-1 is lower than the aforementioned constant, high pressure, the period of volume change of each of the chambers 15-2 is set to a longer time.

More specifically, when the drive voltage signal from the electronic engine control unit 31 arises at time t31, the fuel injection control microcomputer 32a causes the solenoid-operated on-off discharge valve drive circuit section 32b to generate the solenoid valve on-off signal. As a result, at time t32, which is reached after the elapse of the ineffective injection time Td, the pressure of liquid contained in the liquid feed path 15-1 starts to rise beyond the aforementioned constant, low pressure (low-pressure threshold PLo), and, at time t33, reaches the aforementioned constant, high pressure (high-pressure threshold PHi).

In this liquid pressure rise period (from time t32 to time t33), the fuel injection control microcomputer 32a causes the piezoelectric/electrostrictive-element drive circuit section 32c to generate the piezoelectric-element drive signal DV of a first frequency f1. In other words, the frequency f of the piezoelectric-element drive signal DV applied to the piezoelectric/electrostrictive elements 15g is set to the first frequency f1.

Subsequently, when the pressure of liquid contained in the liquid feed path 15-1 becomes the aforementioned constant, high pressure (time t33), the fuel injection control microcomputer 32a sets the frequency f of the piezoelectric-element drive signal DV applied to the piezoelectric/electrostrictive elements 15g to a second frequency f2 higher than the first frequency f1. Notably, such a change in frequency f is performed through changing (shortening) the period T (see FIG. 7) of pulses to be sent to the Schmitt trigger circuits ST11 and ST12 from the fuel injection control microcomputer 32a.

Subsequently, when the drive voltage signal from the electronic engine control unit 31 disappears at time t34, the fuel injection control microcomputer 32a stops generation of the solenoid valve on-off signal applied to the solenoid-operated on-off discharge valve 14. As a result, at time t35, which is reached after the elapse of a predetermined time from time t34, the pressure of liquid contained in the liquid feed path 15-1 starts to lower. Then, at time t36, the liquid pressure becomes the aforementioned constant, low pressure.

Meanwhile, the fuel injection control microcomputer 32a monitors whether or not the detected-liquid-pressure-in-path PS is lower than the high-pressure threshold PHi. When the detected-liquid-pressure-in-path PS becomes lower than the high-pressure threshold PHi (time t35), the fuel injection control microcomputer 32a again sets the frequency f of the piezoelectric-element drive signal DV applied to the piezoelectric/electrostrictive elements 15g to the first frequency f1. Then, when the detected-liquid-pressure-in-path PS becomes equal to or lower than the low-pressure threshold PLo (time t36), the fuel injection control microcomputer 32a causes the piezoelectric/electrostrictive element drive circuit section 32c to stop generation of the piezoelectric-element drive signal DV.

In order to perform the above-described control, the electronic engine control unit 31 executes the previously described drive voltage signal generation routine as represented by the flowchart of FIG. 9. Also, the fuel injection control microcomputer 32a executes the piezoelectric-element activation instruction signal generation routine as represented by the flowchart of FIG. 17 every elapse of a predetermined time. This routine will be briefly described. When the detected-liquid-pressure-in-path PS is higher than the low-pressure threshold PLo and lower than the high-pressure threshold PHi, the fuel injection control microcomputer 32a forms a “Yes” judgment at Step 1705, where whether or not the detected-liquid-pressure-in-path PS is higher than the low-pressure threshold PLo is judged; forms a “No” judgment at subsequent Step 1710, where whether or not the detected-liquid-pressure-in-path PS is equal to or higher than the high-pressure threshold PHi is judged; and proceeds to Step 1715. At Step 1715, the fuel injection control microcomputer 32a generates the piezoelectric-element activation instruction signal for setting the frequency f of the piezoelectric-element drive signal DV to the first frequency f1.

When the detected-liquid-pressure-in-path PS becomes equal to or higher than the high-pressure threshold PHi, the fuel injection control computer 32a forms a “Yes” judgment at Steps 1705 and 1710 and proceeds to Step 1720. At Step 1720, the fuel injection control microcomputer 32a generates the piezoelectric-element activation instruction signal for setting the frequency f of the piezoelectric-element drive signal DV to the second frequency f2.

By contrast, when the detected-liquid-pressure-in-path PS is equal to or lower than the low-pressure threshold PLo, the fuel injection control microcomputer 32a forms a “No” judgment at Step 1705 and proceeds to Step 1725. At Step 1725, the fuel injection control microcomputer 32a stops generation of the piezoelectric-element activation instruction signal, to thereby stop generation of the piezoelectric-element drive signal DV. Execution of the above routine generates the piezoelectric-element drive signal DV having a frequency corresponding to the detected-liquid-pressure-in-path PS.

As described above, the liquid injection apparatus 10 according to the third embodiment is configured in such a manner as to change the frequency of the piezoelectric-element drive signal DV according to the detected-liquid-pressure-in-path PS. In other words, as the detected-liquid-pressure-in-path PS increases, the electrical control unit 30 applies the piezoelectric-element drive signal DV having a higher frequency to the piezoelectric/electrostrictive elements 15g, thereby increasing the frequency of volume change of the chambers 15-2.

Since the pressure of liquid contained in the liquid feed path 15-1 determines the velocity (injection velocity) of liquid injected from each of the liquid discharge nozzles 15-4, the degree of atomization of liquid varies with the pressure of the liquid. Therefore, as in the case of the above-described third embodiment, through changing the frequency f of the piezoelectric-element drive signal DV according to the pressure of liquid contained in the liquid feed path 15-1, liquid droplets of a desired size can be obtained.

Also, in the above-described third embodiment, the piezoelectric-element drive signal DV is changed such that the frequency f of the piezoelectric-element drive signal DV increases with an increase in the pressure of liquid contained in the liquid feed path 15-1. This configuration is employed for the following reason. As the pressure of liquid contained in the liquid feed path 15-1 increases, the velocity of liquid injected from each of the liquid discharge nozzles 15-4 increases, and the flow rate of liquid injected from each of the liquid discharge nozzles 15-4 (the length of a liquid column extruded into the liquid injection space 21 per unit time from each of the liquid discharge nozzles 15-4) increases. Therefore, through application, to the piezoelectric/electrostrictive elements 15g, of the piezoelectric-element drive signal DV whose frequency f increases with the pressure of liquid contained in the liquid feed path 15-1, the size of liquid droplets obtained through atomization can be rendered uniform, irrespective of the liquid pressure.

Notably, in the above-described embodiment, the frequency f of the piezoelectric-element drive signal DV is changed in two stages of the first frequency f1 and the second frequency f2. However, the frequency f may be changed continuously according to the detected-liquid-pressure-in-path PS (such that the frequency f increases with an increase in the detected-liquid-pressure-in-path PS).

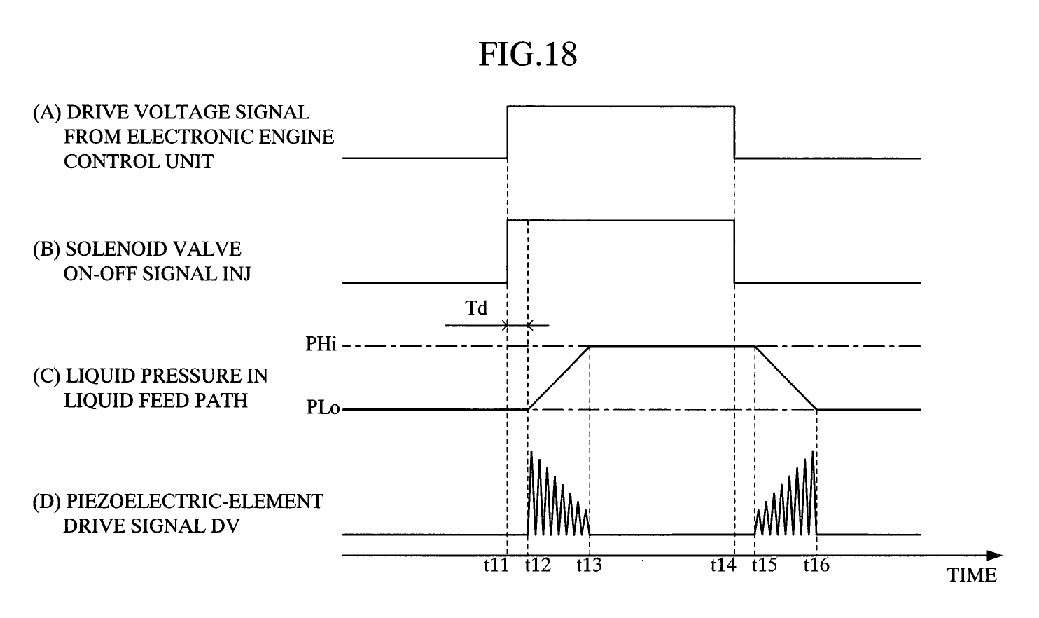

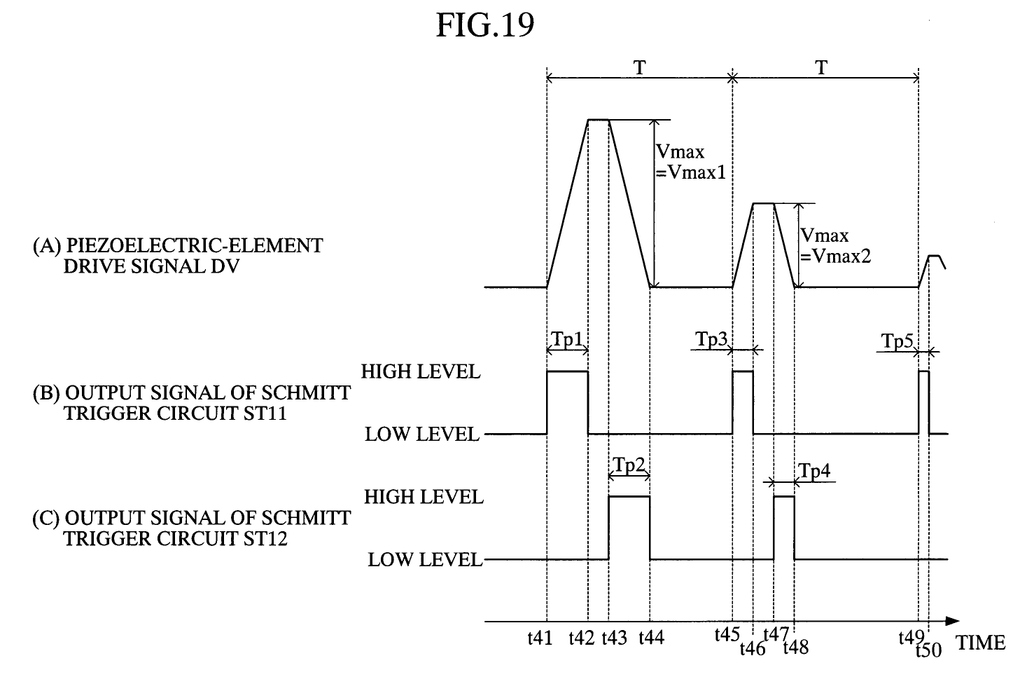

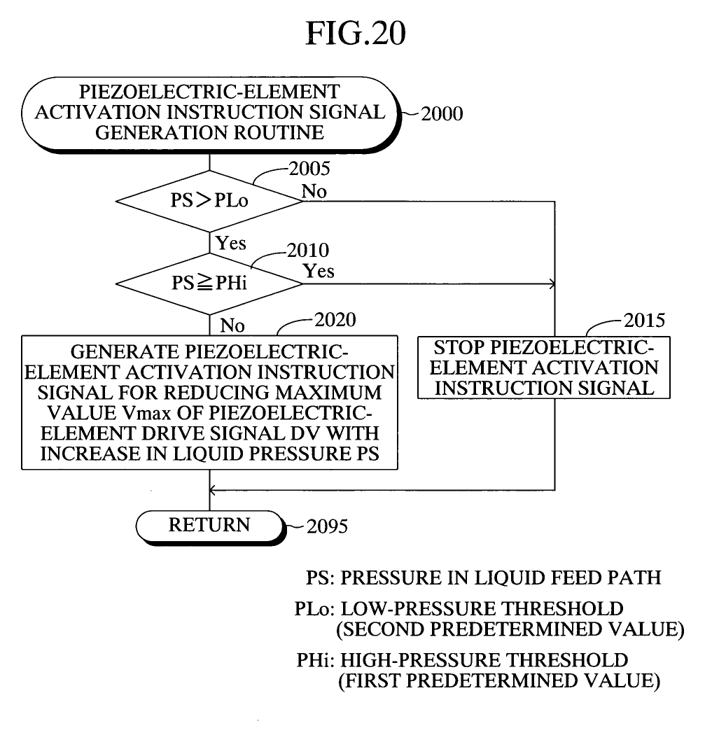

Next, a liquid injection apparatus 10 according to a fourth embodiment of the present invention will be described. The liquid injection apparatus 10 according to the fourth embodiment differs from the liquid injection apparatus 10 according to the first embodiment only in a pattern for generating the solenoid valve on-off signal and the piezoelectric-element drive signal DV. Thus, while the main focus is place on the above point of difference, the fourth embodiment will next be described with reference to the timing charts of FIGS. 18 and 19 and the flowchart of FIG. 20.

In the fourth embodiment, as in the case of the first embodiment, during the period of time (ranging from time t13 to time t15 in FIG. 18) when the liquid pressure PS in the liquid feed path 15-1 is stabilized at the aforementioned constant, high pressure (a pressure equal to or higher than the high-pressure threshold PHi), atomization of fuel effected through activation of the piezoelectric/electrostrictive elements 15g is stopped. Also, during the period of time when the pressure of liquid contained in the liquid feed path 15-1 is in the process of increasing or lowering (ranging from time t12 to time t13 and from time t15 to time t16), the quantity of volume change of the chambers 15-2 caused by the piezoelectric-element drive signal DV is reduced with an increase in the liquid pressure.

In order to perform the above control, the electronic engine control unit 31 executes the previously-described drive voltage signal generation routine as represented by the flowchart of FIG. 9. The fuel injection control microcomputer 32a executes the piezoelectric-element activation instruction signal generation routine as represented by the flowchart of FIG. 20 every elapse of a predetermined time. This routine will be briefly described. When the detected-liquid-pressure-in-path PS is higher than the low-pressure threshold PLo and lower than the high-pressure threshold PHi, the fuel injection control microcomputer 32a forms a “Yes” judgment at Step 2005, where whether or not the detected-liquid-pressure-in-path PS is higher than the low-pressure threshold PLo is judged; forms a “No” judgment at subsequent Step 2010, where whether or not the detected-liquid-pressure-in-path PS is equal to or higher than the high-pressure threshold PHi is judged; and proceeds to Step 2020. At Step 2020, the fuel injection control microcomputer 32a generates the piezoelectric-element activation instruction signal such that the maximum value Vmax of the piezoelectric-element drive signal DV reduces with an increase in the detected-liquid-pressure-in-path PS.

Specifically, during the period of time ranging from time t12 to time t13, the fuel injection control microcomputer 32a sequentially shortens voltage application time spans with the elapse of time; i.e., with an increase in the detected-liquid-pressure-in-path PS, without changing the period T between start of application of the power supply voltage VP2 to the piezoelectric/electrostrictive elements 15g and start of application of the next power supply voltage VP2 to the piezoelectric/electrostrictive elements 15g.

More specifically, as shown in FIG. 19, when the detected-liquid-pressure-in-path PS is in the process of increasing, while the period T between times at which application of power supply voltage VP2 is started (the period of time between time t41 and time t45, and the period of time between time t45 and time t49) is held constant, times Tp1, Tp3, and Tp5—which are voltage application time spans and during which the output signal of the Schmitt trigger circuit ST11 is at high level—are gradually shortened with the elapse of time (with an increase in the detected-liquid-pressure-in-path PS). Through employment of this feature, as the detected-liquid-pressure-in-path PS increases, the maximum voltage Vmax applied to the piezoelectric/electrostrictive elements 15g decreases. Accordingly, the amount of deformation per activation of each of the piezoelectric/electrostrictive elements 15g reduces, whereby the volume change quantity ΔV in a single volume change of each of the chambers 15-2 gradually reduces.

Similarly, in the period of time ranging from time t15 to time t16 shown in FIG. 18, the detected pressure PS of liquid contained in the liquid feed path 15-1 is higher than the low-pressure threshold PLo and lower than the high-pressure threshold PHi. Thus, the fuel injection control microcomputer 32a forms a “Yes” judgment at Step 2005; forms a “No” judgment at Step 2010; and proceeds to Step 2020. At Step 2020, the fuel injection control microcomputer 32a generates the piezoelectric-element activation instruction signal such that the maximum value Vmax of the piezoelectric-element drive signal DV reduces with an increase in the detected-liquid-pressure-in-path PS.

In this case, the pressure of liquid contained in the liquid feed path 15-1 decreases with the elapse of time. Accordingly, the fuel injection control microcomputer 32a gradually prolongs voltage application time spans with the elapse of time without changing the period T of starting application of the power supply voltage VP2 to the piezoelectric/electrostrictive elements 15g. Specifically, a time during which the output signal of the Schmitt trigger circuit ST11 is at high level; i.e., a voltage application time span, is prolonged with a drop in the detected-liquid-pressure-in-path PS. Through employment of this feature, as the detected-liquid-pressure-in-path PS lowers, the amount of deformation per activation of each of the piezoelectric/electrostrictive elements 15g reduces, whereby the volume change quantity ΔV in a single volume change of each of the chambers 15-2 gradually increases.

Meanwhile, when the detected-liquid-pressure-in-path PS is equal to or lower than the low-pressure threshold PLo, or equal to or higher than the high-pressure threshold PHi, the fuel injection control microcomputer 32a forms a “No” judgment at Step 2005 or a “Yes” judgment at Step 2010 and proceeds to Step 2015. At Step 2015, the fuel injection control microcomputer 32a stops generation of the piezoelectric-element activation instruction signal.

As described above, in the liquid injection apparatus 10 according to the fourth embodiment, the quantity of volume change of each of the chambers 15-2 effected by the piezoelectric-element drive signal DV decreases with an increase in the detected-liquid-pressure-in-path PS (the pressure of liquid contained in the liquid feed path 15-1).

As the pressure of liquid contained in the liquid feed path 15-1 increases, the velocity of liquid injected from the liquid discharge nozzles 15-4 increases. Thus, without an increase of the volume change quantity ΔV (the maximum value of volume change quantity; i.e., the maximum volume change quantity) of each of the chambers 15-2, injected liquid droplets assume a relatively small size by virtue of surface tension. Therefore, according to the above-described fourth embodiment, in which the quantity ΔV of volume change of each of the chambers 15-2 effected by the piezoelectric-element drive signal DV reduces with an increase in the pressure of liquid contained in the liquid feed path 15-1, it is possible to prevent the volume of each of the chambers 15-2 from changing to an unnecessarily great extent (i.e., possible to prevent the piezoelectric/electrostrictive elements 15g from deforming by an unnecessarily large amount), thereby reducing the electrical consumption of the liquid injection apparatus 10.

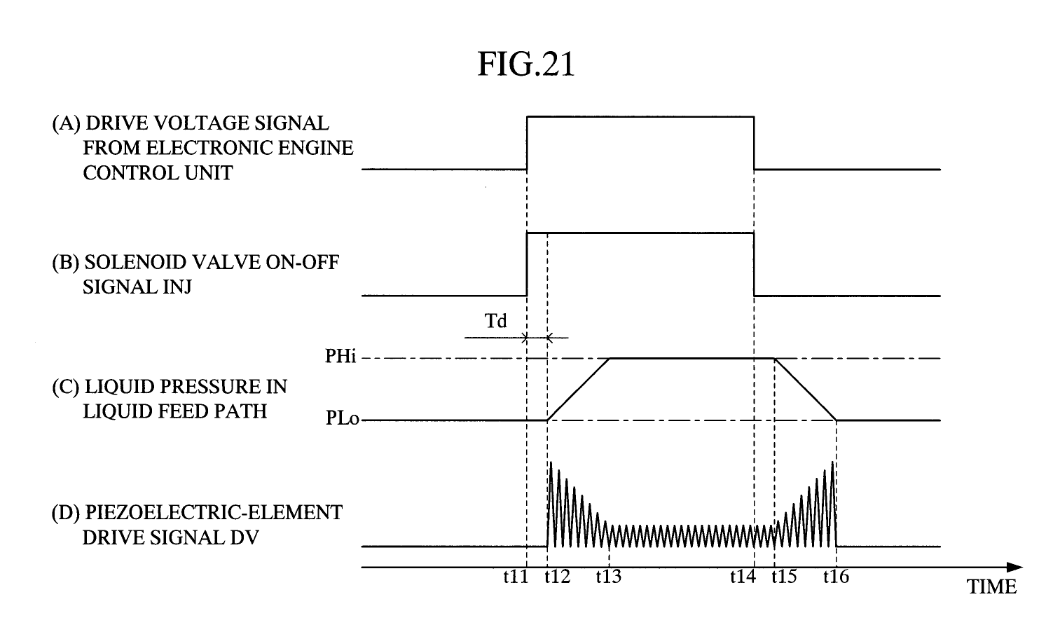

Notably, in the above-described fourth embodiment, while the pressure of liquid contained in the liquid feed path 15-1 is the aforementioned constant, high pressure (from time t13 to time t15), generation of the piezoelectric-element drive signal DV is suspended. However, as shown in FIG. 21, the piezoelectric-element drive signal DV may be continuously generated. Also, the third embodiment and the fourth embodiment may be combined; specifically, the frequency of the piezoelectric-element drive signal DV increases with an increase in the pressure of liquid contained in the liquid feed path 15-1, and the quantity ΔV of volume change of each of the chambers 15-2 effected by the piezoelectric-element drive signal DV reduces with an increase in the liquid pressure.

As described above, in the liquid injection apparatus according to the embodiments of the present invention, fuel is pressurized by the pressure pump 11, whereby fuel under pressure is injected into the liquid injection space 21 in the intake pipe 20; therefore, even when pressure in the liquid injection space 21 (intake pressure) fluctuates, a required amount of fuel can be stably injected.

Vibration energy is applied to fuel through variation of the volume of the chambers 15-2 of the injection device 15A, whereby the fuel is atomized and then injected from the liquid discharge nozzles 15-4. As a result, the present liquid fuel injection apparatus can inject liquid droplets which are atomized to a highly fine degree. Furthermore, since the injection device 15A includes a plurality of chambers 15-2 and a plurality of discharge nozzles 15-4, even when bubbles are generated within fuel, the bubbles tend to be finely divided, thereby avoiding great fluctuations in the amount of injection which would otherwise result from the presence of bubbles.

The direction of fuel discharge from the discharge ports 14c-2 of the solenoid-operated on-off discharge valve 14 is determined such that, as the distance from the discharge ports 14c-2 toward the liquid feed path 15-1 increases, the distance of fuel discharged from the discharge ports 14c-2 as measured from the axis CL of the closed cylindrical space increases. Accordingly, discharged fuel produces a flow in a large region of the closed cylindrical space formed in the sleeve 15D. As a result, bubbles become unlikely to be generated, particularly, in a corner portion (marked with solid black triangles in FIG. 3) of the closed cylindrical space in the vicinity of the discharge ports 14c-2 of the solenoid-operated on-off discharge valve 14, or the performance of eliminating bubbles generated in the corner portion is enhanced. Therefore, in the above-described liquid injection apparatus, a rise in fuel pressure is unlikely to be hindered by bubbles. Thus, since fuel pressure can be increased as expected, fuel droplets can be injected in an amount and at timing as required by mechanical apparatus such as an internal combustion engine.

Also, the above-described liquid injection apparatus are configured such that, before liquid discharged from the solenoid-operated on-off discharge valve 14 is injected into the liquid injection space 21 from the liquid discharge nozzles 15-4, the flow of the liquid makes a substantially right-angled turn at least once (in the present example, four times).

Specifically, in the present liquid injection apparatus, since the liquid inlet 15-5 and the liquid feed path 15-1 meet at right angles, the flow of liquid discharged from the solenoid-operated on-off discharge valve 14 makes a right-angled turn at a connection portion of the liquid inlet 15-5 and the liquid feed path 15-1. Next, since the major-axis direction of the liquid feed path 15-1 is in parallel with the X-axis, and the axis of each of the liquid introduction holes 15-3 is in parallel with the Z-axis, the flow of liquid makes a right-angled turn at a connection portion of the liquid feed path 15-1 and each of the liquid introduction holes 15-3.

Furthermore, since the major axis of each of the chambers 15-2 is in parallel with the Y-axis, and the axis of each of the liquid introduction holes 15-3 is in parallel with the Z-axis, the flow of liquid makes a right-angled turn at a connection portion of each of the chambers 15-2 and the corresponding liquid introduction hole 15-3. Also, since the major axis of each of the chambers 15-2 is in parallel with the Y-axis, and the axis of each of the liquid discharge nozzles 15-4 is in parallel with the Z-axis, the flow of liquid also makes a right-angled turn at a connection portion of each of the chambers 15-2 and the corresponding liquid discharge nozzle 15-4.

According to the above-described configuration, since the flow of liquid discharged from the solenoid-operated on-off discharge valve 14 makes a right-angled turn at least once, pulsation of liquid pressure due to opening of the solenoid-operated on-off discharge valve 14 is reduced, thereby enabling stable injection of liquid droplets. In other words, a dynamic pressure which accompanies opening of the solenoid-operated on-off discharge valve 14 becomes a static pressure, and fuel is injected under the static pressure. As a result, fuel can be stably injected from the liquid discharge nozzles 15-4.

Particularly, in the above-described liquid injection apparatus, the injection device 15A includes a plurality of chambers 15-2 connected to the common liquid feed path 15-1, and the flow of liquid discharged from the solenoid-operated on-off discharge valve 14 makes a substantially right-angled turn at a connection portion of the liquid inlet 15-5 and the liquid feed path 15-1, whereby the pressure of liquid contained in the liquid feed path 15-1 is stabilized. Accordingly, the pressure of liquid contained in the chambers 15-2 becomes a static pressure to thereby be stabilized, thereby enabling discharge of uniform liquid droplets from the liquid discharge nozzles 15-4 connected to the corresponding chambers 15-2.

The solenoid-operated on-off discharge valve 14 is arranged and configured such that the discharge flow line (represented in FIG. 3 by the dot-and-dash line DL) of liquid discharged from the discharge ports 14c-2 directly intersects a plane portion of the liquid feed path 15-1 (the upper surface of the ceramic sheet 15b) without intersecting the side wall 15D-1 which forms the closed cylindrical space of the sleeve 15D, and without intersecting the side wall WP which is formed through imaginary extension of the side wall 15D-1 to the plane portion of the liquid feed path 15-1.

As a result, since liquid discharged from the solenoid-operated on-off discharge valve 14 reaches the plane portion of the liquid feed path 15-1 while maintaining high kinetic energy (velocity), the liquid is strongly reflected from the plane portion toward the discharge ports 14c-2 in the closed cylindrical space. Accordingly, since the flow of reflected liquid eliminates bubbles stagnant in a corner portion (marked with solid black triangles in FIG. 3) of the closed cylindrical space in the vicinity of the discharge ports 14c-2, the amount of bubbles present in liquid reduces. Accordingly, in the above-described liquid injection apparatus, a rise in liquid pressure is more unlikely to be hindered by bubbles. Thus, since liquid pressure can be increased as expected, liquid droplets can be injected in an amount and at timing as required by an internal combustion engine.

Furthermore, since the axis of each of the liquid discharge nozzles 15-4 of the above-described embodiments is in parallel with the Z-axis, liquid droplets discharged into the liquid injection space 21 from the liquid discharge nozzles 15-4 do not substantially intersect in the process of flying, thereby avoiding formation of liquid droplets of a greater size, which would otherwise result from collision of fuel liquid droplets in the liquid injection space 21. Thus, fuel can be sprayed in a uniformly atomized condition.

In the liquid injection apparatus according to the above-described embodiments, the electrical control unit 30 is configured in such a manner as to generate the piezoelectric-element drive signal DV so as to activate the piezoelectric/electrostrictive elements 15g when the pressure of liquid contained in the liquid feed path 15-1 is at least in the process of increasing or decreasing (when the detected-liquid-pressure-in-path PS is in the process of increasing or decreasing) because of generation of the solenoid valve on-off signal or stoppage of generation of the solenoid valve on-off signal, and in such a manner as not to generate the piezoelectric-element drive signal DV when the pressure of liquid contained in the liquid feed path 15-1 is a constant, low pressure because of disappearance of the solenoid valve on-off signal.

Accordingly, even in the case where the injection velocity of liquid is not sufficiently high to sufficiently atomize the liquid, because of the pressure of liquid contained in the liquid feed path 15-1 (and the chambers 15-2) being relatively low at the time of the pressure of the liquid being in the process of increasing or decreasing, the liquid can be appropriately atomized by changing the volume of the chambers 15-2 through activation of the piezoelectric/electrostrictive elements 15g.

Also, when the pressure of liquid contained in the liquid feed path 15-1 (detected-liquid-pressure-in-path PS) is a constant, low pressure (a pressure that the liquid contained in the liquid feed path 15-1 reaches as a result of continuation of a state in which the liquid feed path 15-1 is not fed with liquid pressurized by the pressurizing device) equal to or lower than the predetermined value PLo because of disappearance of the solenoid valve on-off signal; i.e., when liquid is never injected into the liquid injection space 21 from the liquid discharge nozzles 15-4 of the injection device 15A, the injection device 15A does not need to perform the action of atomizing liquid. Thus, in such a case, the electrical control unit 30 does not generate the piezoelectric-element drive signal DV. This allows the liquid injection apparatus to avoid waste of electricity.

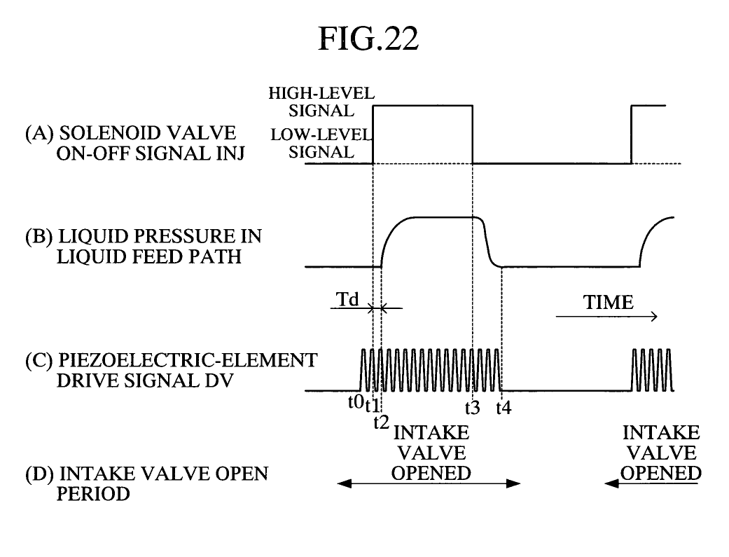

Notably, the present invention is not limited to the above-described embodiments, but may be modified in various forms without departing from the scope of the invention. For example, as shown in FIG. 22, the piezoelectric-element drive signal DV may be generated at time t0 which precedes time t1 when the solenoid valve on-off signal is generated.

In this case, at time t0 slightly before time t2 when fuel injection starts, the electronic engine control unit 31 sends an activation start instruction signal for instructing start of activation of the piezoelectric/electrostrictive elements 15g, to the fuel injection control microcomputer 32a. In response to the activation start instruction signal, the fuel injection control microcomputer 32a sends a control signal to the piezoelectric/electrostrictive-element drive circuit section 32c to thereby generate the piezoelectric-element drive signal DV. Also, the fuel injection control microcomputer 32a monitors whether or not the detected-liquid-pressure-in-path PS is equal to or lower than the low-pressure threshold PLo. When the detected-liquid-pressure-in-path PS becomes equal to or lower than the low-pressure threshold PLo, the fuel injection control microcomputer 32a stops generation of the piezoelectric-element drive signal DV.

According to the above-described configuration, at time t2 when injection of liquid droplets possibly starts in response to generation of the solenoid valve on-off signal, the piezoelectric/electrostrictive elements 15g have already been driven by the piezoelectric-element drive signal DV, and thus vibration energy has already been applied to liquid. Therefore, from the beginning of liquid injection, liquid droplets can be injected in a reliably atomized condition.

Furthermore, the above-described embodiments employ the liquid feed path pressure sensor 35. However, one of the plurality of piezoelectric/electrostrictive elements 15g of the injection device 15A may be used as the liquid feed path pressure sensor 35. This allows elimination of the liquid feed path pressure sensor 35, thereby lowering the cost of the liquid injection apparatus.

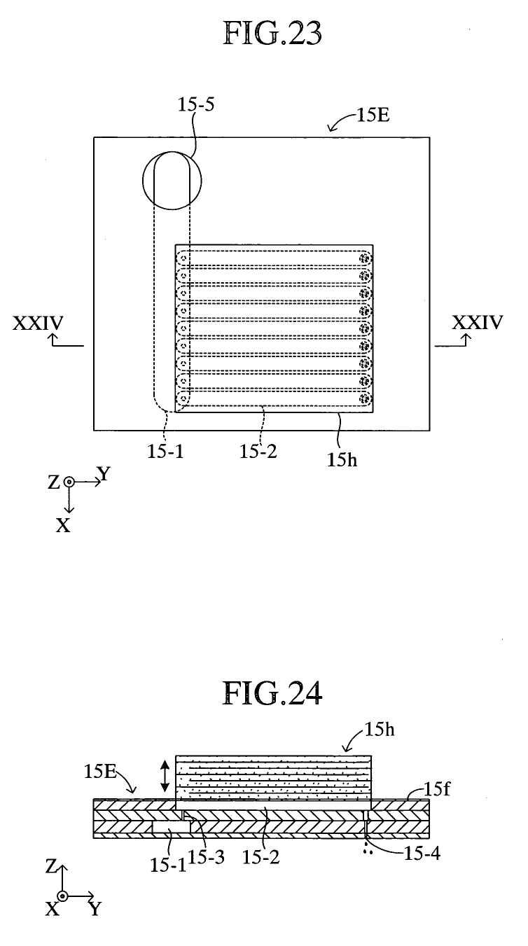

The injection device 15A may be replaced with an injection device 15E shown in FIGS. 23 and 24. As shown in FIG. 23, which is a plan view of the injection device 15E, and FIG. 24, which is a sectional view of the injection device 15E cut by a plane extending along line XXIV-XXIV of FIG. 23, a piezoelectric/electrostrictive element 15h of the injection device 15E assumes the form of laminate. Specifically, the piezoelectric/electrostrictive element 15h is a “laminated piezoactuator” formed such that laminar piezoelectric/electrostrictive elements and laminar electrodes are alternatingly arranged in layers. When positive and negative voltages of a drive voltage signal are applied alternatingly with the elapse of time between paired comb-type electrodes, the piezoelectric/electrostrictive element 15h causes the ceramic sheet 15f to be deformed.

The liquid injection apparatus of the above-described embodiments are applied to a gasoline-fueled internal combustion engine in which fuel is injected into the intake pipe (intake port). However, the liquid injection apparatus of the present invention can be applied to a so-called “direct-injection-type gasoline-fueled internal combustion engine,” in which fuel is injected directly into cylinders. Specifically, when fuel is injected directly into a cylinder by an electrically controlled fuel injection apparatus which uses a conventional fuel injector, fuel may be caught in a gap (crevice) between a cylinder and a piston, potentially resulting in an increase in the amount of unburnt HC (hydrocarbon). By contrast, when fuel is injected directly into a cylinder by use of the liquid injection apparatus according to the present invention, fuel is injected in an atomized condition into the cylinder, whereby the amount of fuel adhesion to the inner wall surface of the cylinder can be reduced, or the amount of fuel entering the gap between a cylinder and a piston can be reduced, thereby reducing exhaust of unburnt HC.

Furthermore, the liquid injection apparatus according to the present invention is effectively used as a direct injector for use in a diesel engine. Specifically, a conventional injector involves a problem of failure to inject atomized fuel, particularly in low-load operation of the engine, in which fuel pressure is low. In this case, if a common-rail-type injection apparatus is used, fuel pressure can be increased to a certain extent even when the engine is rotating at low speed, and thus atomization of injected fuel can be improved. However, since fuel pressure is lower as compared with the case where the engine is rotating at high speed, fuel cannot be sufficiently atomized. By contrast, since the liquid injection apparatus according to the present invention is configured such that fuel is atomized through activation of the piezoelectric/electrostrictive elements 15g, sufficiently atomized fuel can be injected irrespective of engine load (i.e., even when the engine is running at low load).

What is claimed is:

1. A liquid injection apparatus comprising:
an injection device including a liquid discharge nozzle, a first end of the liquid discharge nozzle being exposed to a liquid injection space, a piezoelectric/electrostrictive element which is activated by a piezoelectric-element drive signal that vibrates at a predetermined frequency, a chamber connected to a second end of the liquid discharge nozzle, a liquid feed path connected to the chamber, and a liquid inlet establishing communication between the liquid feed path and the exterior of the injection device;
a pressurizing device for pressurizing liquid;
a solenoid-operated on-off discharge valve including a solenoid-operated on-off valve which is driven by a solenoid valve on-off signal, and a discharge port which is opened and closed by the solenoid-operated on-off valve, the solenoid-operated on-off discharge valve receiving the liquid pressurized by the pressurizing device, and discharging the pressurized liquid into the liquid inlet of the injection device via the discharge port when the solenoid-operated on-off valve is driven to open the discharge port;
a pressure detection device for detecting liquid pressure at a certain location in a liquid path extending from the discharge port of the solenoid-operated on-off discharge valve to the first end of the liquid discharge nozzle exposed to the liquid injection space; and
an electrical control unit for sending the piezoelectric-element drive signal to the piezoelectric/electrostrictive element and the solenoid valve on-off signal to the solenoid-operated on-off discharge valve,
wherein the piezoelectric/electrostrictive element is driven in such a manner that the liquid discharged from the solenoid-operated on-off discharge valve is atomized and injected into the liquid injection space in the form of droplets from the liquid discharge nozzle, and
wherein the electrical control unit is configured in such a manner as to change the piezoelectric-element drive signal on the basis of the liquid pressure detected by the pressure detection device.

2. A liquid injection apparatus according to claim 1,
wherein the pressure detection device is a piezoelectric element disposed in the liquid feed path, the liquid inlet, or the chamber.

3. A liquid injection apparatus according to claim 1,
wherein the pressure detection device is a piezoresistance element disposed in the liquid feed path, the liquid inlet, or the chamber.

4. A liquid injection apparatus according to claim 1,
wherein the pressure detection device is the piezoelectric/electrostrictive element of the injection device.

5. A liquid injection apparatus according to any one of claims 1 to 4,
wherein the electrical control unit is configured in such a manner as to generate the piezoelectric-element drive signal so as to activate the piezoelectric/electrostrictive element when the liquid pressure detected by the pressure detection device is in the process of increasing or decreasing because of generation of the solenoid valve on-off signal or stoppage of generation of the solenoid valve on-off signal, and in such a manner as not to generate the piezoelectric-element drive signal when the liquid pressure detected by the pressure detection device is a constant, low pressure because of disappearance of the solenoid valve on-off signal.

6. A liquid injection apparatus according to any one of claims 1 to 5,
wherein the electrical control unit is configured in such a manner as not to generate the piezoelectric-element drive signal when the liquid pressure detected by the pressure detection device is equal to or higher than a high-pressure threshold.

7. A liquid injection apparatus according to any one of claims 1 to 4,
wherein the electrical control unit is configured in such a manner as to continuously generate the piezoelectric-element drive signal, during a period in which the liquid pressure detected by the pressure detection device is higher than a low-pressure threshold because of generation of the solenoid valve on-off signal, and is configured in such a manner as to generate the solenoid valve on-off signal such that the pressure of liquid contained in the liquid feed path increases steeply immediately after start of generation of the solenoid valve on-off signal and subsequently decreases gradually at a pressure change rate whose absolute value is smaller than that of a pressure change rate at the time of the increase of the liquid pressure.

8. A liquid injection apparatus according to claim 7,
wherein the electrical control unit is configured in such a manner as to change the solenoid valve on-off signal on the basis of the liquid pressure detected by the pressure detection device.

9. A liquid injection apparatus according to any one of claims 1 to 8,
wherein the electrical control unit is configured in such a manner as to change the frequency of the piezoelectric-element drive signal according to the liquid pressure detected by the pressure detection device.

10. A liquid injection apparatus according to any one of claims 1 to 9,
wherein the electrical control unit is configured in such a manner as to change the piezoelectric-element drive signal such that the frequency of the piezoelectric-element drive signal increases with an increase in the liquid pressure detected by the pressure detection device.

11. A liquid injection apparatus according to any one of claims 1 to 10,
wherein the electrical control unit is configured in such a manner as to change the piezoelectric-element drive signal such that the volume change quantity of the chamber reduces with an increase in the liquid pressure detected by the pressure detection device.
